(19) United States
(12) Patent Application Publication
(10) Pub. No.: US 2023/0158771 A1
(43) Pub. Date: May 25, 2023

(54) DECORATIVE FILM, DECORATIVE MOLDED ARTICLE, DECORATIVE PANEL, AND ELECTRONIC DEVICE

(71) Applicant: FUJIFILM CORPORATION, Tokyo (JP)

(72) Inventors: Yuichi HAYATA, Kanagawa (JP); Yuka MATSUMOTO, Kanagawa (JP); Takuma KAWAMOTO, Kanagawa (JP)

(21) Appl. No.: 18/158,480

(22) Filed: Jan. 24, 2023

Related U.S. Application Data
(63) Continuation of application No. PCT/JP2021/023962, filed on Jun. 24, 2021.

(30) Foreign Application Priority Data
Jul. 30, 2020 (JP) 2020-129501
Dec. 24, 2020 (JP) 2020-215029

(51) Int. Cl. B32B 3/30; B32B 7/023; C09K 19/38; C09K 19/56; C09K 19/58

(52) U.S. Cl. CPC B32B 3/30; B32B 7/023; C09K 19/3852; C09K 19/56; C09K 19/588; G02F 2201/343; G02F 1/1337

(57) ABSTRACT

Provided are a decorative film including a base material and a reflective layer having a convex structure, in which, in a cross section obtained by cutting the convex structure in a direction perpendicular to a plane direction of the decorative film, in a case where a direction in which an average Φ_{AVE} of positive tilt angles is a largest is defined as a first direction and a direction in which the average Φ_{AVE} of the positive tilt angles is a smallest is defined as a second direction, the decorative film has a region A in which Φ_{AVE} in the first direction is 3° or more and Φ_{AVE} in the second direction is less than 3°; and applications thereof.

### CROSS-REFERENCE TO RELATED APPLICATIONS

This application is a continuation application of International Application No. PCT/JP2021/023962, filed Jun. 24, 2021, the disclosure of which is incorporated herein by reference in its entirety. Further, this application claims priority from Japanese Patent Application No. 2020-129501, filed Jul. 30, 2020, and Japanese Patent Application No. 2020-215029, filed Dec. 24, 2020, the disclosures of which are incorporated herein by reference in their entireties.

### BACKGROUND OF THE INVENTION

### 1. Field of the Invention

The present disclosure relates to a decorative film, a decorative molded article, a decorative panel, and an electronic device.

### 2. Description of the Related Art

A decorative molded article, in which a decorative film is disposed on a surface of a resin molded article to color the surface in a desired color tone or to provide a desired pattern on the surface of the resin molded article, has been known. The decorative molded article is obtained, for example, by previously disposing a decorative film in a mold and injection-molding a base material resin into the mold, thereby having a structure in which the surface of the resin molded article is integrated with the decorative film. The injection mold of the base material resin after previously disposing the decorative film in the mold is generally referred to as film insert molding or simply insert molding. In addition, the decorative molded article may be manufactured by attaching a decorative film to a molded article after molding.

As a hot stamp foil in the related art, JP2001-105795A discloses a hot stamp foil characterized in that a cholesteric liquid crystalline polymer layer having a selective reflection wavelength range in visible light is laminated as a transfer layer. In addition, JP2017-97114A discloses that retroreflective property is improved by subjecting a cholesteric liquid crystal layer to an uneven processing.

### SUMMARY OF THE INVENTION

An object to be achieved by one embodiment of the present disclosure is to provide a decorative film having a rich tint change depending on a viewing direction.

An object to be achieved by another embodiment of the present disclosure is to provide a decorative molded article including the decorative film or a decorative panel including the decorative film.

An object to be achieved by still another embodiment of the present disclosure is to provide an electronic device including the decorative panel.

The present disclosure includes the following aspects.

<1> A decorative film comprising:

a base material; and

a reflective layer having a convex structure,

in which, in a cross section obtained by cutting the convex structure in a direction perpendicular to a plane direction of the decorative film, in a case where a direction in which an average Φ_{AVE} of positive tilt angles is a largest is defined as a first direction and a direction in which the average Φ_{AVE} of the positive tilt angles is a smallest is defined as a second direction, the decorative film has a region A in which Φ_{AVE} in the first direction is 3° or more and Φ_{AVE} in the second direction is less than 3°.

<2> The decorative film according to <1>,

in which the region A in the plane direction of the decorative film includes a region having a size equal to or larger than a circle having a radius of 150 μm.

<3> The decorative film according to <1> or <2>,

in which the decorative film further has a region B in-plane, which has a second direction different from the second direction of the region A.

<4> The decorative film according to <3>,

in which a distance between the region A and the region B in the plane direction of the decorative film is 1 mm or less.

<5> The decorative film according to any one of <1> to <4>,

in which, in a cross-sectional shape obtained by cutting the convex structure in the region A in the direction perpendicular to the plane direction of the decorative film and in the first direction, a tilt angle Φ_{1/2} at an intermediate height point H_{1/2} between a local maximum point and a local minimum point of the positive tilt angle is 3° or more and less than 60°.

<6> The decorative film according to any one of <1> to <4>,

in which, in a cross-sectional shape obtained by cutting the convex structure in the region A in the direction perpendicular to the plane direction of the decorative film and in the first direction, a tilt angle Φ_{1/2} at an intermediate height point H_{1/2} between a local maximum point and a local minimum point of the positive tilt angle is 60° or more.

<7> The decorative film according to any one of <1> to <6>,

in which, in a cross-sectional shape obtained by cutting the convex structure in the region A in the direction perpendicular to the plane direction of the decorative film and in the first direction, an area proportion of a region where a tilt angle Φ is 0° or more and less than 3° is 50% or less with respect to a total area of the region A.

<8> The decorative film according to any one of <1> to <7>,

in which, in a cross-sectional shape obtained by cutting the convex structure in the region A in the direction perpendicular to the plane direction of the decorative film and in the first direction, an area proportion of a region where a tilt angle Φ is 3° or more and less than 45° is 40% or more with respect to a total area of the region A.

<9> The decorative film according to any one of <1> to <8>,

in which, in a cross-sectional shape obtained by cutting the convex structure in the region A in the direction perpendicular to the plane direction of the decorative film and in the first direction, an area proportion of a region where a tilt angle Φ is 3° or more and less than 7° is 40% or more with respect to a total area of the region A.

<10> The decorative film according to any one of <1> to <9>,

in which, in a cross-sectional shape obtained by cutting the convex structure in the region A in the direction perpendicular to the plane direction of the decorative film and in the first direction, a distance between local minimum points of the positive tilt angles is less than 100 μm.

<11> The decorative film according to any one of <1> to <10>,

in which, in a cross-sectional shape obtained by cutting the convex structure in the region A in the direction perpendicular to the plane direction of the decorative film and in the first direction, a distance between local minimum points of the positive tilt angles is 10 μm or more.

<12> he decorative film according to any one of <1> to <11>,

in which the reflective layer includes a liquid crystal in a cholesteric alignment state. <13> The decorative film according to any one of <1> to <12>,

in which the convex structure is a linear convex structure.

<14> The decorative film according to <13>,

in which a linear convex structure includes a linear convex structure having a ratio L/W of a length L to an average line width W of 5 or more.

<15> A decorative molded article comprising:

the decorative film according to any one of <1> to <14>; or

a molded product of the decorative film.

<16> A decorative panel comprising:

the decorative film according to any one of <1> to <14>; or

a molded product of the decorative film.

<17> An electronic device comprising:

the decorative panel according to <16>.

<A1> A decorative film including:

a base material; and

a reflective layer having a plurality of linear convex structures,

in which, with regard to a shape of the linear convex structure,

1) a ratio (L/W) of a length (L) to an average line width (W) is 5 or more, and

2) at least a region where an angle formed by a length (L) direction of a single linear convex structure is 45° or more is provided.

<A2> A decorative film including:

a base material; and

a reflective layer having a plurality of linear convex structures,

in which, with regard to a shape of the linear convex structure,

1) a ratio (L/W) of a length (L) to an average line width (W) is 5 or more, and

2) at least a region where an angle formed by length (L) directions between adjacent linear convex structures is 45° or more is provided in-plane.

<A3> A decorative film including:

a base material; and

a reflective layer having a plurality of linear convex structures,

in which, with regard to a shape of the linear convex structure,

1) a ratio (L/W) of a length (L) to an average line width (W) is 5 or more, and

2) a region where a relationship between an average line width Wa=(W1+W2)/2 of adjacent convex structures and a distance (D) between vertices of the convex structures is D>1.5 Wa is provided.

<A4> A decorative film including:

a base material; and

a reflective layer having a plurality of linear convex structures,

in which, with regard to a shape of the linear convex structure,

1) a ratio (L/W) of a length (L) to an average line width (W) is 5 or more, and

2) a tilt of a cross-sectional shape at an intermediate point between a local maximum point and a local minimum point of the convex structure is 60° or more.

<A5> A decorative film according to any one of <A1> to <A4>,

in which the reflective layer is a layer including a cholesteric liquid crystal.

<A6> A decorative molded article including the decorative film according to any one of <A1> to <A5>.

<A7> A decorative panel including the decorative film according to any one of <A1> to <A5>.

<A8> An electronic device including the decorative panel according to <A7>.

According to one embodiment of the present disclosure, it is possible to provide a decorative film having a rich tint change depending on a viewing direction.

According to another embodiment of the present disclosure, it is possible to provide a decorative molded article including the decorative film or a decorative panel including the decorative film.

According to another embodiment of the present disclosure, it is possible to provide an electronic device including the decorative panel.

### BRIEF DESCRIPTION OF THE DRAWINGS

FIG. 1 is a schematic cross-sectional view showing an example of a decorative film according to an embodiment of the present disclosure.

FIG. 2 is a schematic cross-sectional view showing an example of a decorative film according to an embodiment of the present disclosure.

FIG. 3 is a schematic cross-sectional view showing an example of a decorative molded article according to an embodiment of the present disclosure.

FIG. 4 is a schematic cross-sectional view showing an example of the decorative molded article according to the embodiment of the present disclosure.

FIG. 5 is a schematic cross-sectional view showing an example of the decorative molded article according to the embodiment of the present disclosure.

FIG. 6 is a schematic cross-sectional view showing an example of a decorative panel according to an embodiment of the present disclosure.

FIGS. 7(a) to 7(c) are schematic diagrams showing an example of a convex base material pattern (A).

FIGS. 8A to 8E are schematic diagrams showing an example of a convex base material pattern (B).

FIG. 9 is a schematic diagram showing an example of an optical mask pattern.

FIG. 10 is a schematic cross-sectional view showing an example of a decorative panel for a display according to the present disclosure.

FIG. 11 is an enlarged schematic view of a region of a reflective layer having a convex structure in an example of the decorative film according to the embodiment of the present disclosure.

FIGS. 12A to 12C are schematic cross-sectional views of directions A to C in FIG. 11 and schematic views showing a tilt angle Φ.

### DESCRIPTION OF THE PREFERRED EMBODIMENTS

Hereinafter, a decorative film according to an embodiment of the present disclosure will be described. However, the present disclosure is not limited to the following embodiments, and can be implemented with appropriate modification within the scope of the object of the present disclosure. In a case where the embodiments of the present disclosure are described with reference to the drawings, the description of overlapping constituent elements and reference numerals may be omitted. The constituent elements indicated by the same reference numeral in the drawings mean the same constituent element. A dimensional ratio in the drawings does not necessarily represent the actual dimensional ratio.

In a case where substitution or unsubstitution is not noted in regard to the notation of a “group” (atomic group) in the present disclosure, the “group” includes not only a group not having a substituent but also a group having a substituent. For example, an “alkyl group” includes not only an alkyl group having no substituent (unsubstituted alkyl group), but also an alkyl group having a sub stituent (substituted alkyl group).

In the present disclosure, “light” means an actinic ray or radiation.

In the present disclosure, “actinic ray” or “radiation” means, for example, a bright line spectrum of a mercury lamp, far ultraviolet ray typified by an excimer laser, extreme ultraviolet ray (EUV light), X-ray, electron beam (EB), and the like.

In the present disclosure, unless otherwise specified, “exposure” includes not only exposure by a bright line spectrum of a mercury lamp, far ultraviolet ray typified by an excimer laser, extreme ultraviolet ray (EUV light), X-ray, and the like, but also exposure by a particle beam such as an electron beam and an ion beam.

In the present disclosure, “to” is used to refer to a meaning including numerical values denoted before and after “to” as a lower limit value and an upper limit value.

In the present disclosure, (meth)acrylate represents acrylate and methacrylate, and (meth)acrylic represents acrylic and methacrylic.

In the present disclosure, a weight-average molecular weight (Mw), a number-average molecular weight (Mn), and a dispersity (also referred to as molecular weight distribution) (Mw/Mn) of a resin component are defined as a value in terms of polystyrene according to a gel permeation chromatography (GPC) measurement (solvent: tetrahydrofuran, flow amount (sample injection amount): 10 μL, column: TSK gel Multipore HXL-M manufactured by Tosoh Corporation, column temperature: 40° C., flow rate: 1.0 mL/min, detector: refractive index detector) using a GPC device (HLC-8120GPC manufactured by Tosoh Corporation).

In the present disclosure, in a case where a plurality of substances corresponding to each component in a composition is present, the amount of each component in the composition means the total amount of the plurality of substances present in the composition, unless otherwise specified.

In the present disclosure, a term “step” denotes not only an individual step but also a step which is not clearly distinguishable from another step as long as an effect expected from the step can be achieved.

In the present disclosure, a “total solid content” refers to a total mass of components obtained by removing a solvent from the whole composition of the composition. In addition, a “solid content” is a component obtained by removing a solvent from the whole composition of the composition, and for example, the component may be solid or may be liquid at 25° C.

In the present disclosure, “% by mass” has the same definition as that for “% by weight”, and “part by mass” has the same definition as that for “part by weight”.

In addition, in the present disclosure, a combination of two or more preferred aspects is a more preferred aspect.

(Decorative Film)

A decorative film according to the embodiment of the present disclosure includes a base material and an optical thin film coloring by optical interference or structural color.

Specifically, the decorative film according to the embodiment of the present disclosure includes a base material and a reflective layer having a convex structure, in which, in a cross section obtained by cutting the convex structure in a direction perpendicular to a plane direction of the decorative film, in a case where a direction in which an average Φ_{AVE} of positive tilt angles is the largest is defined as a first direction and a direction in which the average Φ_{AVE} of the positive tilt angles is the smallest is defined as a second direction, the decorative film has a region A in which Φ_{AVE} in the first direction is 3° or more and Φ_{AVE} in the second direction is less than 3°.

An application of the decorative film according to the embodiment of the present disclosure is not particularly limited, and specific examples thereof include a decoration of electronic devices (for example, wearable devices and smartphones), home appliances, audio products, computers, displays, in-vehicle products, watches, accessories, optical parts, doors, window glasses, and building materials. Among these, the decorative film according to the embodiment of the present disclosure can be suitably used for a decoration of electronic devices (for example, wearable devices and smartphones). In addition, since the decorative film according to the embodiment of the present disclosure has excellent three-dimensional moldability, the decorative film according to the embodiment of the present disclosure is suitable as a decorative film for molding, which is used for molding such as three-dimensional molding and insert molding, and more suitable as a decorative film for three-dimensional molding.

In the related art, as a surface decoration used in articles such as home appliances, electronic apparatuses, and mobile phones, for example, printing, painting, vapor deposition, or plating has been used. However, for example, from the aspects of problems such as functionality addition and environmental load, and the possibility of replacement, a decoration technique by using a decorative film has been widely used. On the other hand, new designability is required from the widespread preference of users. In particular, change in color (for example, a tint and a fine hue) depending on a viewing angle is one of required designs, and a need for introducing the decoration technique to obtain the designs has been required. In addition, in JP2001-105795A, a hot stamp foil in which a cholesteric liquid crystalline polymer layer is laminated as a transfer layer is disclosed, but since reflected color changes depending on a viewing angle, a uniform tint cannot be obtained. In addition, in JP2017-97114A, it is disclosed that retroreflective property is improved by subjecting a cholesteric liquid crystal layer to an uneven processing, but there is no disclosure of its use as a decorative film and its effects.

As a result of intensive studies by the present inventors, it has been found that, according to the decorative film including the above-described configuration, a decorative film which is useful as a material for a decorative molded article having a rich tint change depending on a viewing direction. In the present disclosure, the “having a rich tint change depending on a viewing direction” means that, for example, there is a large change in tint between a case where an object is viewed from an angle perpendicular to a surface direction of the object and a case where the object is viewed at an angle of 45° with respect to the surface direction of the object. The above-described effect is preferable in that impact of a design can be improved.

Hereinafter, the decorative film according to the embodiment of the present disclosure will be described in detail.

<Base Material>

The decorative film according to the embodiment of the present disclosure has a base material. The base material may be a support. As the base material, for example, a known base material in the related art as a base material used for molding such as three-dimensional molding and insert molding can be used without particular limitation, and may be appropriately selected according to suitability for molding. In addition, a shape and a material of the base material are not particularly limited, and may be appropriately selected as desired. From the viewpoint of ease of molding and chipping resistance, the base material is preferably a resin base material, and more preferably a resin film.

Specific examples of the base material include a resin film including a resin such as polyethylene terephthalate (PET), polyethylene naphthalate (PEN), an acrylic resin, a urethane resin, a urethane-acrylic resin, polycarbonate (PC), an acrylic-polycarbonate resin, triacetyl cellulose (TAC), cycloolefin polymer (COP), and acrylonitrile/butadiene/styrene copolymer resin (ABS resin). Among these, from the viewpoint of moldability and strength, the base material is preferably polyethylene terephthalate (PET), an acrylic resin, polycarbonate, or polypropylene, and more preferably polyethylene terephthalate (PET), an acrylic resin, or polycarbonate. In addition, the base material may be a laminated resin base material having two or more layers. Preferred examples thereof include a laminated film including an acrylic resin layer and a polycarbonate layer.

The base material may contain other additives as necessary. Examples of such additives include lubricants (for example, mineral oil, hydrocarbons, fatty acids, alcohols, fatty acid esters, fatty acid amides, metallic soaps, natural waxes, and silicone), inorganic flame retardants (for example, magnesium hydroxide and aluminum hydroxide), a halogen-based organic flame retardant, a phosphorus-based organic flame retardant, organic or inorganic fillers (for example, metal powder, talc, calcium carbonate, potassium titanate, glass fibers, carbon fibers, and wood powder), an antioxidant, an ultraviolet inhibitor, a dispersant, a coupling agent, a foaming agent, a colorant, and engineering plastics other than the above-described resins. Examples of the engineering plastics include polyolefins, polyesters, polyacetals, polyamides, and polyphenylene ethers.

As the base material, a commercially available product may be used. Examples of the commercially available product include TECHNOLLOY (registered trademark) series (acrylic resin film or acrylic resin/polycarbonate resin laminated film, manufactured by Sumitomo Chemical Co., Ltd.), ABS films (manufactured by Okamoto Industries, Inc.), ABS sheets (manufactured by SEKISUI SEIKEI CO., LTD.), Teflex (registered trademark) series (PET film, manufactured by TEIJIN FILM SOLUTIONS LIMITED), Lumirror (registered trademark) easily moldable type (PET film, manufactured by TORAY INDUSTRIES, INC), and Purethermo (polypropylene film, manufactured by Idemitsu Kosan Co., Ltd.).

A thickness of the base material is determined according to, for example, the application of a molded product to be produced and handleability, and is not particularly limited. The lower limit of the thickness of the base material is preferably 1 μm or more, more preferably 10 μm or more, still more preferably 20 μm or more, and particularly preferably 30 μm or more. The upper limit of the thickness of the base material is preferably 500 μm or less, more preferably 200 μm or less, and particularly preferably 100 μm or less.

<Reflective Layer>

The decorative film according to the embodiment of the present disclosure includes a reflective layer having a convex structure, in which, in a cross section obtained by cutting the convex structure in a direction perpendicular to a plane direction of the decorative film, in a case where a direction in which an average Φ_{AVE} of positive tilt angles is the largest is defined as a first direction and a direction in which the average Φ_{AVE} of the positive tilt angles is the smallest is defined as a second direction, the decorative film has a region A in which Φ_{AVE} in the first direction is 3° or more and Φ_{AVE} in the second direction is less than 3°.

A method of determining the above-described first direction and the above-described second direction in the present disclosure is shown below.

The above-described convex structure is cut in an arbitrary plane (that is, 360° existing as a direction) perpendicular to a plane direction of the decorative film, and a direction in which an average Φ_{AVE} of positive tilt angles is the largest and a direction in which the average Φ_{AVE} of the positive tilt angles is the smallest are determined.

As a method of calculating the average Φ_{AVE} of the positive tilt angles, with regard to a region which includes the above-described convex structure and has a size equal to or larger than a circle having a radius of 150 μm, an average value of only a portion where the tilt angle of the convex structure portion is 0° or more in a cross section obtained by cutting the convex structure in one direction is defined as the above-described average Φ_{AVE} of the positive tilt angles. A portion where the tilt angle is negative is excluded from the calculation of the average Φ_{AVE} of the positive tilt angles.

In addition, the above-described positive tilt angle is an angle with respect to the plane direction of the decorative film, and a portion of more than 90° and less than 180° is a tilt angle opposite to the measurement direction of the positive tilt angle and is a portion of less than 90° and more than 0° of a negative tilt angle.

As the method of calculating the average Φ_{AVE} of the positive tilt angle, specifically, a microtome (for example, RX-860 manufactured by YAMATO KOHKI INDUSTRIAL CO., LTD.) is used to cut the decorative film on an arbitrary plane in a direction (360° existing as a direction) perpendicular to the plane direction of the decorative film. The cutting direction can be predicted to some extent by observing the surface of the decorative film with a microscope (for example, BX53M manufactured by Olympus Corporation). A cross-sectional shape is measured by observing the cut cross section with a scanning electron microscope (for example, SU3800 manufactured by Hitachi High-Tech Corporation), and Φ_{AVE} is calculated as described above.

In addition, examples of a method for measuring the cross-sectional shape other than the above-described method include a method of measuring a surface shape of the convex structure using a laser microscope (for example, VK-X1000 manufactured by KEYENCE CORPORATION), and in a case where the convex structure can be measured in three dimensions, the cross-sectional shape may be calculated from a three-dimensional shape.

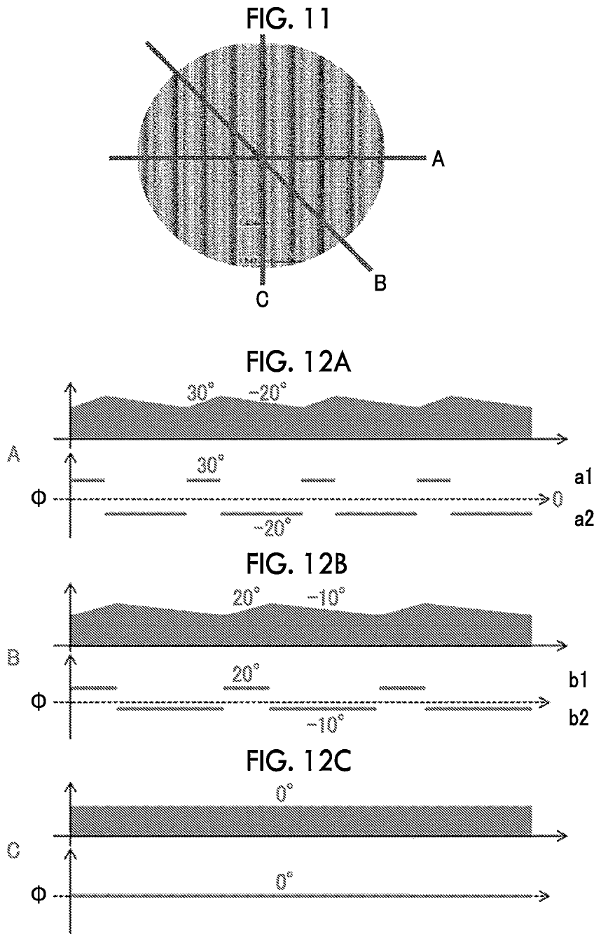

More specifically, the description will be made with reference to FIG. 11 and FIGS. 12A to 12C.

FIG. 11 is an enlarged schematic view of a region of a reflective layer having a convex structure in an example of the decorative film according to the embodiment of the present disclosure.

As the convex structure of the reflective layer in FIG. 11, a plurality of linear convex structures in which a vertical direction in FIG. 11 is a longitudinal direction are formed.

Straight lines A, B, and C in FIG. 11 indicate directions for cutting the above-described convex structure. FIGS. 12A to 12C show cross sections obtained by cutting the above-described convex structure in the direction indicated by the straight line A (direction A), the direction indicated by the straight line B (direction B), or the direction indicated by the straight line C (direction C). In FIGS. 12A to 12C, A shows a cross section of the above-described convex structure cut in the direction A, B shows a cross section of the above-described convex structure cut in the direction B, and C shows a cross section of the above-described convex structure cut in the direction C, respectively.

As shown in FIG. 12A, the cross section of the convex structure in the direction A has tilt angles Φ of 30° and −20°. A bar indicated by a1 shows a distribution of the positive tilt angle, and a bar indicated by a2 shows a distribution of the negative tilt angle.

In the direction A, the average Φ_{AVE} of the positive tilt angles is determined as 30°. As described above, the calculation is performed excluding the negative tilt angle of −20°.

In addition, as shown in FIG. 12B, the cross section of the convex structure in the direction B has tilt angles Φ of 20° and −10°. A bar indicated by b1 shows a distribution of the positive tilt angle, and a bar indicated by b2 shows a distribution of the negative tilt angle.

In the direction B, the average Φ_{AVE} of the positive tilt angles is determined as 20°. As described above, the calculation is performed excluding the negative tilt angle of −10°.

Furthermore, as shown in FIG. 12C, the cross section of the convex structure in the direction C is flat, and the tilt angle Φ is 0°.

In the direction C, the average Φ_{AVE} of the positive tilt angles is determined as 0°.

The same operation is performed at 360° (in a case where the first direction and the second direction are predicted to some extent, the operation can be omitted) to determine the first direction in which the average Φ_{AVE} of the positive tilt angles is the largest and the second direction in which the average Φ_{AVE} of the positive tilt angles is the smallest.

In the region having the convex structure shown in FIG. 11 and FIGS. 12A to 12C, Φ_{AVE} in the first direction is 30° and Φ_{AVE} in the second direction is 0°.

In the present disclosure, the convex structure means that convex undulations are formed with respect to a specific plane.

In the decorative film according to the embodiment of the present disclosure, it is sufficient that the above-described reflective layer has the convex structure, and the surface of the decorative film itself may be flat (preferably, the decorative film does not have a convex structure with a height of 1 μm or more on the surface).

A shape of the above-described convex structure is not particularly limited, and examples thereof include various shapes such as a linear structure, a spiral structure, a concentric circular structure, and a wavy linear structure.

The linear shape in the present disclosure means that the shape has a length in a specific direction. Specifically, preferred examples thereof include an aspect in which a ratio (L/W) of a length (L) to an average line width (W) is 5 or more.

In addition, the cross-sectional shape of the above-described convex structure is also not particularly limited, and examples thereof include an aspect in which the cross-sectional shape in the direction perpendicular to the plane direction of the decorative film and the direction perpendicular to the longitudinal direction of the convex structure has various shapes such as triangular, square, rectangular, trapezoidal, semicircular, and semielliptical.

For example, in a case where the decorative film has, in-plane, a region where a plurality of linear convex structures are arranged and a region where a plurality of linear convex structures different from the linear convex structures of the region are arranged in the longitudinal direction, it is possible to obtain a decorative film having visibility in which one region is bright and the other region is dark depending on the viewing direction of each region.

In addition, for example, in a case where the decorative film has, in-plane, a region having a concentric circular convex structure, it is possible to obtain a decorative film having visibility in which bright and dark portions are generated radially from the center of concentric circles in the region and the bright and dark portions change depending on the viewing direction.

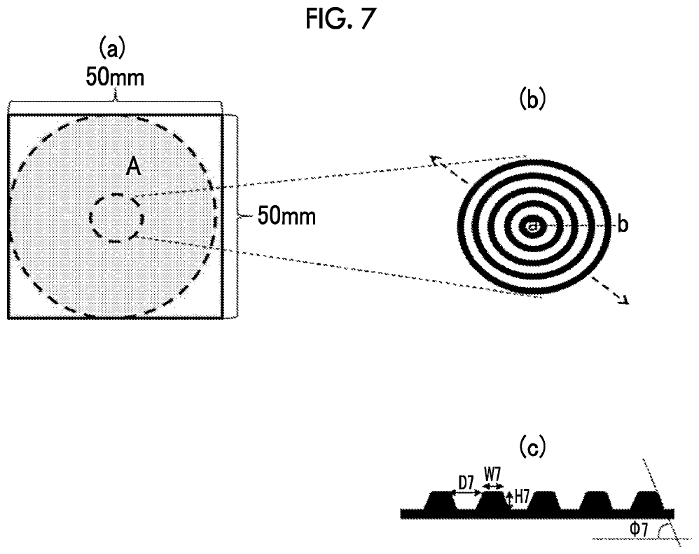

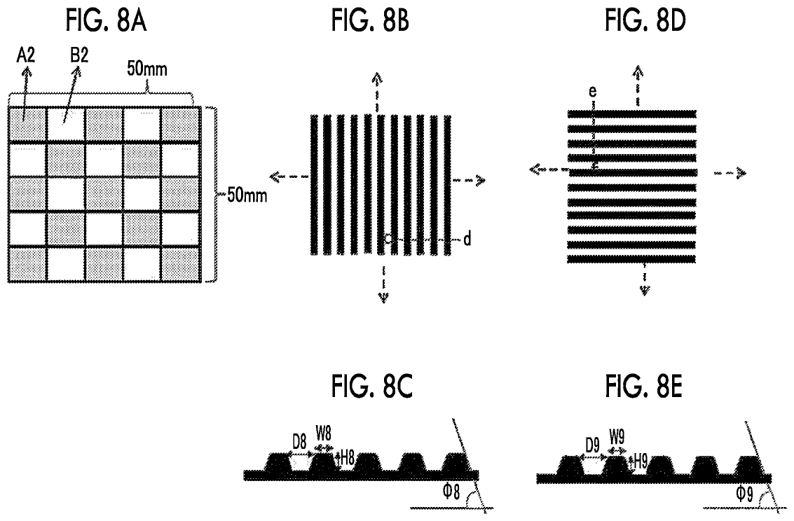

Suitable examples thereof include convex structures shown in FIGS. 7(a) to 7(c) and FIGS. 8A to 8E.

FIG. 7(a) is a schematic diagram showing an example of a region A1 in which a concentric circular convex structure is formed, and indicates a pattern area.

FIG. 7(b) is a diagram showing the details of the region A1 in FIG. 7(a) and is a schematic diagram seen from the direction perpendicular to the plane direction of the decorative film and from a side (upper surface) where the convex structure is formed, and the concentric circular convex structure is formed in a region of 50 mm in diameter. A black line portion in FIG. 7(b) shows a linear convex shape, and the same pattern is repeated up to the diameter of 50 mm.

FIG. 7(c) is a diagram showing an example of a cross-sectional view between a and b shown in FIG. 7(b).

FIGS. 8A to 8E are schematic diagrams showing an example (region A1) of the region A in which a plurality of linear convex structures are formed.

FIG. 8A is a schematic diagram seen from the direction perpendicular to the plane direction of the decorative film and from the side where the convex structure is formed, and is a schematic diagram showing an example that two types of 10 mm×10 mm regions (region A2 and region B2) in which a plurality of linear convex structures with different longitudinal directions of the linear convex structure are formed are spread in the above-described plane direction with a size of 50 mm×50 mm. In FIG. 8A, the region A2 is designated as A2, and the region B2 is designated as B2.

FIG. 8B shows the details of the region A2, and the same pattern is repeated up to 10 mm×10 mm.

FIG. 8C is a diagram showing an example of a cross-sectional view between c and d shown in FIG. 8B.

FIG. 8D shows the details of the region B2, and the same pattern is repeated up to 10 mm×10 mm.

FIG. 8E is a diagram showing an example of a cross-sectional view between e and f shown in FIG. 8D.

The convex structure preferably has a periodic pitch. The pitch is an interval between adjacent convex portions in the convex structure. The interval between the convex portions is a distance between the highest point of the convex portion and the highest point of the convex portion.

For example, in a case where the convex structure has a hemispherical shape, the pitch corresponds to a distance between vertices of two hemispherical convex portions which are closest to each other. For example, in a case where the convex structure has a triangular shape, the pitch corresponds to a distance between vertices of two triangular convex portions which are closest to each other.

In addition, in a case where the convex structure has a hemispherical shape, a tilt angle at a certain point of the convex structure portion in the above-described cross section is a tilt angle of the tangent line at the point.

From the viewpoint of obtaining visibility rich in color change depending on the viewing angle and viewpoint of lustrousness, a height (H) of the convex structure is preferably 1 μm or more, more preferably 1 μm to 100 μm, still more preferably 2 μm to 30 μm, particularly preferably 3 μm to 20 μm, and most preferably 4 μm to 10 μm.

In the present disclosure, an in-plane average value of a height difference between adjacent local maximum portion and local minimum portion of a convex surface, obtained using a laser microscope (for example, VK-X1000 manufactured by KEYENCE CORPORATION), is adopted as the height of the convex structure. The surface to be measured is a surface (that is, the convex surface) of the convex structure of the exposed reflective layer. However, in a case where a layer covering the reflective layer has a convex structure and the convex structure of the layer covering the reflective layer can be considered to be substantially the same as the convex structure of the reflective layer, a height of the convex structure of the layer covering the reflective layer may be adopted as the height of the convex structure of the reflective layer.

From the viewpoint of obtaining visibility rich in color change depending on the viewing angle and viewpoint of lustrousness, a width (W) of the convex structure is preferably 1 μm or more, more preferably 2 μm to 200 μm, still more preferably 30 μm to 100 μm, and particularly preferably 4 μm to 40 μm.

In the present disclosure, an in-plane average value of a distance between the local maximum portion and the local minimum portion of the convex portion, obtained using a laser microscope (for example, VK-X1000 manufactured by KEYENCE CORPORATION), is adopted as the width of the convex structure. The surface to be measured is a surface (that is, the convex surface) of the convex structure of the exposed reflective layer. However, in a case where a layer covering the reflective layer has a convex structure and the convex structure of the layer covering the reflective layer can be considered to be substantially the same as the convex structure of the reflective layer, a width of the convex structure of the layer covering the reflective layer may be adopted as the width of the convex structure of the reflective layer.

A length (L) of the convex structure is not particularly limited and can be appropriately selected as desired, but from the viewpoint of obtaining visibility rich in color change depending on the viewing angle and viewpoint of lustrousness, the length (L) thereof is preferably 5 μm or more, more preferably 10 μm to 100 m, still more preferably 30 μm to 20 m, and particularly preferably 50 μm to 10 m.

In the present disclosure, the length (L) of the linear convex structure can be measured by observing the linear convex structure with a laser microscope (for example, VK-X1000 manufactured by KEYENCE CORPORATION) or the like. The surface to be measured is a surface (that is, the convex surface) of the convex structure of the exposed reflective layer. However, in a case where a layer covering the reflective layer has a convex structure and the convex structure of the layer covering the reflective layer can be considered to be substantially the same as the convex structure of the reflective layer, a length of the convex structure of the layer covering the reflective layer may be adopted as the length of the convex structure of the reflective layer.

From the viewpoint of obtaining visibility rich in color change depending on the viewing angle and viewpoint of lustrousness, a ratio (width:height) of the width of the convex structure and the height of the convex structure is preferably 20:1 to 1:2, more preferably 10:1 to 1:0.8, still more preferably 8:1 to 1:1, and particularly preferably 4:1 to 1:1.2.

A ratio of a height HD of the convex structure of the reflective layer to a thickness HT of the reflective layer is preferably H_{D}/H_{T}>0.1 and 0.5<H_{D}/H_{T}<200, more preferably 1<H_{D}/H_{T}<100, and particularly preferably 5<H_{D}/H_{T}<50.

The thickness of the reflective layer represents a distance between the upper surface and the lower surface of the reflective layer.

In a case where the decorative film according to the embodiment of the present disclosure has a linear convex structure, a ratio (L/W) of a length (L) of the linear convex structure to an average line width (W) is preferably 5 or more, more preferably 8 or more, still more preferably 10 or more, and particularly preferably 20 or more. Within the above-described range, lustrousness is high, and visibility rich in color change depending on the viewing angle is obtained.

In a case where the decorative film according to the embodiment of the present disclosure has a linear convex structure, a single linear convex shape preferably has at least a region where an in-plane direction of the length (L) forms an angle of 45° or more, more preferably has at least a region where an in-plane direction of the length (L) forms an angle of 60° or more, still more preferably has at least a region where an in-plane direction of the length (L) forms an angle of 70° or more, and particularly preferably has at least a region where an in-plane direction of the length (L) forms an angle of 90° or more. Within the above-described range, lustrousness is high, and visibility rich in color change depending on the viewing angle is obtained. Here, in the single linear convex shape, within the line width (W), adjacent convex shapes in which an angle formed by the in-plane direction of the length (L) is less than 20° are considered within the range of the single convex shape.

In a case where the decorative film according to the embodiment of the present disclosure has a linear convex structure, it is preferable to have at least a region in-plane where an angle formed by the length (L) direction of adjacent linear convex structures is 45° or more, it is more preferable to have at least a region in-plane where an angle formed by the length (L) direction of adjacent linear convex structures is 60° or more, it is still more preferable to have at least a region in-plane where an angle formed by the length (L) direction of adjacent linear convex structures is 70° or more, and it is particularly preferable to have at least a region in-plane where an angle formed by the length (L) direction of adjacent linear convex structures is 80° or more. Within the above-described range, lustrousness is high, and visibility rich in color change depending on the viewing angle is obtained. Here, the “adjacent” means that the linear convex structures are adjacent to each other at a distance within 10 times an average value Wa=(W1+W2)/2 of line widths (W1 and W2) of adjacent linear convex shapes.

In a case where the decorative film according to the embodiment of the present disclosure has a linear convex structure, it is preferable to include a region where a relationship between a distance (D) between vertices of adjacent convex structures and the average line width Wa=(W1+W2)/2 of the adjacent convex structures is D>1.5 Wa, it is more preferable to include a region where 1.75 Wa≤D≤10 Wa, it is still more preferable to include a region where 1.8 Wa≤D≤8 Wa, and it is particularly preferable to include a region where 2 Wa≤D≤6 Wa. Within the above-described range, lustrousness is high, and visibility rich in color change depending on the viewing angle is obtained.

In a case where the decorative film according to the embodiment of the present disclosure has a linear convex structure, the above-described region A preferably includes a convex structure in which the tilt angle Φ of the cross-sectional shape at an intermediate height point (H_{1/2}) between the local maximum point and the local minimum point of the convex structure is 60° or more, more preferably includes a convex structure in which the tilt angle Φ thereof is 70° or more, and still more preferably includes a convex structure in which the tilt angle Φ thereof is 80° or more. Within the above-described range, lustrousness is high, and visibility rich in color change depending on the viewing angle is obtained.

From the viewpoint of visibility and change in tint depending on the viewing direction, the above-described region A in the plane direction of the above-described decorative film includes a region having a size equal to or larger than a circle having a radius of 150 μm. The upper limit of the size of the above-described region A is an area of one surface of the decorative film.

In addition, two or more of the regions A in the plane direction of the decorative film may be present, and there is no particular limitation on the size of each region A, and all of the regions A may have the same size or two or more thereof may have different sizes.

The decorative film according to the embodiment of the present disclosure may have a region other than the above-described region A in the plane direction of the decorative film, and may have one or more regions having a convex structure different from the above-described region A or may have a region not having a convex structure.

In addition, from the viewpoint of lustrousness and change in tint depending on the viewing direction, the decorative film according to the embodiment of the present disclosure preferably further has a region B in-plane, in which the above-described second direction is different from the above-described region A, more preferably further has a region C in-plane, in which the above-described second direction is different from the above-described region A and the region B, and still more preferably further has a region D in-plane, in which the above-described second direction is different from the above-described regions A to C.

In addition, from the viewpoint of lustrousness and change in tint depending on the viewing direction, it is preferable that each of the above-described regions B to D is a region in which Φ_{AVE} in the above-described first direction is 3° or more and Φ_{AVE} in the above-described second direction is less than 3°.

In the decorative film according to the embodiment of the present disclosure, the total area of regions including the above-described regions A to D in the plane of the decorative film, in which Φ_{AVE} in the above-described first direction is 3° or more and Φ_{AVE} in the above-described second direction is less than 3°, is not particularly limited, but from the viewpoint of visibility, opal visibility, and change in tint depending on the viewing direction, the total area thereof is preferably 10 area % to 100 area %, more preferably 20 area % to 100 area %, still more preferably 30 area % to 100 area %, and particularly preferably 50 area % to 100 area %.

A distance between the above-described region A and the above-described region B in the plane direction of the decorative film is not particularly limited, but from the viewpoint of lustrousness and viewpoint that it is easily visible a contrast between the bright portion and the dark portion, the distance is preferably 5 mm or less, more preferably 1 mm or less, and particularly preferably 0.5 mm or less. The lower limit value of the above-described distance is 0 mm, that is, the above-described region A and the above-described region B may be in contact with each other.

In the cross-sectional shape obtained by cutting the above-described convex structure in the above-described region A in the direction perpendicular to the plane direction of the above-described decorative film and in the above-described first direction, for example, from the viewpoint of lustrousness in a case of being viewed on the table and displayed, a tilt angle Φ_{1/2} at the intermediate height point H_{1/2} between the local maximum point and the local minimum point of the positive tilt angle in a case of being viewed from the front is preferably 3° or more and less than 60°, more preferably 3° or more and less than 20°, and particularly preferably 3° or more and less than 7°.

As positions of the above-described local maximum point and the above-described local minimum point, for example, in a case where the above-described cross-sectional shape is a semicircular convex structure, a vertex portion of the semicircular convex structure is the local maximum point, and a contact portion of the semicircular arc and the diameter is the local minimum point. In addition, in this case, the intermediate height point H_{1/2} is a position at a height which is half the height of the semicircular convex structure.

In addition, in the cross-sectional shape obtained by cutting the above-described convex structure in the above-described region A in the direction perpendicular to the plane direction of the above-described decorative film and in the above-described first direction, for example, from the viewpoint of lustrousness in a case where a decoration product decorated with the decorative film is held in a hand and viewed obliquely, the tilt angle Φ_{1/2} at the intermediate height point H_{1/2} between the local maximum point and the local minimum point of the positive tilt angle in a case of being viewed obliquely, especially in a case of being viewed obliquely at an angle of 45° or more from a direction perpendicular to the surface is preferably 60° or more, more preferably 60° or more and less than 90°, and particularly preferably 60° or more and less than 75°.

In the cross-sectional shape obtained by cutting the above-described convex structure in the above-described region A in the direction perpendicular to the plane direction of the above-described decorative film and in the above-described first direction, from the viewpoint of darkening the dark portion in the bright and dark portion to strengthen the contrast, an area proportion of a region where the tilt angle Φ is 0° or more and less than 3° is preferably 50% or less, more preferably 35% or less, and particularly preferably 25% or less with respect to the total area of the above-described region A. The lower limit value of the above-described area proportion is 0%.

In addition, in the cross-sectional shape obtained by cutting the above-described convex structure in the above-described region A in the direction perpendicular to the plane direction of the above-described decorative film and in the above-described first direction, from the viewpoint of brightening the bright portion in the bright and dark portion to strengthen the contrast, an area proportion of a region where the tilt angle Φ is 3° or more and less than 45° is preferably 40% or more, more preferably 50% or more and 90% or less, and particularly preferably 60% or more and 80% or less with respect to the total area of the above-described region A.

In addition, in the cross-sectional shape obtained by cutting the above-described convex structure in the above-described region A in the direction perpendicular to the plane direction of the above-described decorative film and in the above-described first direction, from the viewpoint of brightening the bright portion in the bright and dark portion in a case of being viewed from the front to strengthen the contrast, an area proportion of a region where the tilt angle Φ is 3° or more and less than 7° is preferably 20% or more, more preferably 40% or more, and particularly preferably 50% or more and 90% or less.

In the cross-sectional shape obtained by cutting the above-described convex structure in the above-described region A in the direction perpendicular to the plane direction of the above-described decorative film and in the above-described first direction, from the viewpoint of reducing the visibility of the convex structure and obtaining specular reflectivity, a distance between the local minimum points of the positive tilt angles is preferably less than 150 μm, more preferably less than 100 μm, and particularly preferably less than 50 μm.

In addition, in the cross-sectional shape obtained by cutting the above-described convex structure in the above-described region A in the direction perpendicular to the plane direction of the above-described decorative film and in the above-described first direction, from the viewpoint of suppressing occurrence of rainbow pattern due to interference, the distance between the local minimum points of the positive tilt angles is preferably 5 μm or more, more preferably 10 μm or more, and particularly preferably 20 μm or more.

In addition, in each region such as the above-described region A, from the viewpoint of lustrousness, visibility, change in tint depending on the viewing direction, and suppression of occurrence of rainbow pattern due to interference, a distance between vertices of adjacent convex structures in a case of having a plurality of convex structures is preferably 5 μm or more and less than 150 μm, more preferably 10 μm or more and less than 100 μm, and particularly preferably 20 μm or more and less than 50 μm.

A method for forming the convex structure in the reflective layer is not particularly limited, and suitable examples thereof include a method of producing a mold in which a shape corresponding to a linear convex structure is formed in advance, and transferring a convex shape to a base material on which a reflective layer having no convex structure has been laminated, and a method in which a reflective layer is deformed along a convex shape after the convex shape is transferred to a base material before the formation of the reflective layer. In either case, a resin layer described later, which easily follows the convex shape, can be provided on the base material. Examples of the transfer method include a method of directly applying pressure to the substrate, a method of applying pressure using a roll-type laminator, and a method of applying pressure using a vacuum laminator.

In addition, examples of a method of forming the convex structure in the reflective layer include a method of forming the convex structure by sputtering an inorganic compound such as inorganic particles onto a base material having the convex structure.

The reflective layer preferably has a central wavelength of a selective reflection wavelength in a range of 300 nm or more and 1,500 nm or less.

Examples of the reflective layer include a layer including a liquid crystal in a cholesteric alignment state (also simply referred to as a “cholesteric liquid crystal layer”), a layer including flat metal particles, an optical multilayer film, and a layer including a chromic material. Among the above-described reflective layers, from the viewpoint of lustrousness and change in tint depending on the viewing direction, a cholesteric liquid crystal layer or a layer including an optical multilayer film is preferable, and from the viewpoint of increasing the change in tint depending on the viewing direction, a cholesteric liquid crystal layer is more preferable.

<<Liquid Crystal Composition>>

The cholesteric liquid crystal layer is a layer obtained by curing a liquid crystal composition. The liquid crystal composition is a composition containing a liquid crystal compound. From the viewpoint of moldability and temporary support peeling property, as the liquid crystal compound used in the present disclosure, it is preferable to use at least a cholesteric liquid crystal compound having one ethylenically unsaturated group or one cyclic ether group. For example, the liquid crystal composition for forming the cholesteric liquid crystal layer contains, with respect to a total solid content of the liquid crystal composition, 25% by mass or more of the cholesteric liquid crystal compound having one ethylenically unsaturated group or one cyclic ether group, and furthermore, may contain other components (for example, a chiral agent, an alignment control agent, a polymerization initiator, and an alignment assistant).

—Cholesteric Liquid Crystal Compound having One Ethylenically Unsaturated Group or One Cyclic Ether Group—

It is preferable that the liquid crystal composition contains, as the liquid crystal compound, 25% by mass or more of a cholesteric liquid crystal compound (hereinafter, also referred to as a “specific liquid crystal compound”) having one ethylenically unsaturated group or one cyclic ether group.

The ethylenically unsaturated group in the specific liquid crystal compound is not particularly limited, and examples thereof include a (meth)acryloxy group, a (meth)acrylamide group, a vinyl group, a vinyl ester group, and a vinyl ether group. As the ethylenically unsaturated group, from the viewpoint of reactivity, a (meth)acryloxy group, a (meth)acrylamide group, or an aromatic vinyl group is preferable, a (meth)acryloxy group or a (meth)acrylamide group is more preferable, and a (meth)acryloxy group is particularly preferable.

The cyclic ether group in the specific liquid crystal compound is not particularly limited, but from the viewpoint of reactivity, an epoxy group or an oxetanyl group is preferable, and an oxetanyl group is particularly preferable.

From the viewpoint of reactivity, and suppressing change in reflectance and change in tint after molding, the specific liquid crystal compound is preferably a cholesteric liquid crystal compound having one ethylenically unsaturated group. The liquid crystal composition more preferably contains 25% by mass or more of the cholesteric liquid crystal compound having one ethylenically unsaturated group with respect to the total solid content of the liquid crystal composition.

The specific liquid crystal compound may have both ethylenically unsaturated group and cyclic ether group in one molecule, but it is assumed that the number of ethylenically unsaturated groups is 1 or the number of cyclic ether groups is 1. In addition, in a case where the number of ethylenically unsaturated groups in the specific liquid crystal compound is 1, for example, the specific liquid crystal compound may be a compound having one ethylenically unsaturated group and one or more cyclic ether groups.

In a case where the liquid crystal composition includes a cholesteric liquid crystal compound having one ethylenically unsaturated group, from the viewpoint of suppressing change in reflectance and change in tint after molding, the above-described liquid crystal composition preferably includes a radical polymerization initiator, and more preferably includes a photoradical polymerization initiator.

In a case where the liquid crystal composition includes a cholesteric liquid crystal compound having one cyclic ether group, from the viewpoint of suppressing change in reflectance and change in tint after molding, the above-described liquid crystal composition preferably includes a cationic polymerization initiator, and more preferably includes a photocationic polymerization initiator.

From the viewpoint of suppressing change in reflectance and change in tint after molding, the specific liquid crystal compound is preferably a cholesteric liquid crystal compound having both ethylenically unsaturated group and cyclic ether group, and more preferably a cholesteric liquid crystal compound having one ethylenically unsaturated group and one cyclic ether group.

It is sufficient that the specific liquid crystal compound is a compound having a liquid crystal structure, and the specific liquid crystal compound may be a rod-like liquid crystal compound or a disk-like liquid crystal compound. From the viewpoint of ease of adjusting a pitch of a helical structure in the cholesteric liquid crystal layer, and viewpoint of suppressing change in reflectance and change in tint after molding, the specific liquid crystal compound is preferably a rod-like liquid crystal compound.

As the rod-like liquid crystal compound, azomethines, azoxys, cyano biphenyls, cyanophenyl esters, benzoic acid esters, cyclohexane carboxylic acid phenyl esters, cyanophenyl cyclohexanes, cyano-substituted phenyl pyrimidines, alkoxy-substituted phenyl pyrimidines, phenyl dioxanes, tolanes, or alkenylcyclohexylbenzonitriles are preferably used. In addition to the above-described low-molecular weight liquid crystal compounds, a liquid crystalline polymer compound can also be used. As the rod-like liquid crystal compound, a compound having one ethylenically unsaturated group or one cyclic ether group, among compounds described in “Makromol. Chem., vol. 190, p. 2255 (1989), Advanced Materials, vol. 5, p. 107 (1993)”, U.S. Pat. Nos. 4,683,327A, 5,622,648A, 5,770,107A, WO1995/022586A, WO1995/024455A, WO1997/000600A, WO1998/023580A, WO1998/052905A, JP1989-272551A (JP-H1-272551A), JP1994-16616A (JP-H6-16616A), JP1995-110469A (JP-H7-110469A), JP1999-80081A (JP-H11-80081A), and JP2001-328973A, can be used. Furthermore, as the rod-like liquid crystal compound, for example, a compound having one ethylenically unsaturated group or one cyclic ether group, among compounds described in JP1999-513019A (JP-H11-513019A) and JP2007-279688A, can also be preferably used. The cholesteric liquid crystal layer is more preferably a layer in which the alignment is fixed by polymerizing the rod-like liquid crystal compound.

As the discotic liquid crystal compound, for example, a compound having one ethylenically unsaturated group or one cyclic ether group, among compounds described in JP2007-108732A or JP2010-244038A, can be preferably used.

Preferred specific examples of the specific liquid crystal compound include compounds shown below, but it is needless to say that the specific liquid crystal compound is not limited thereto.

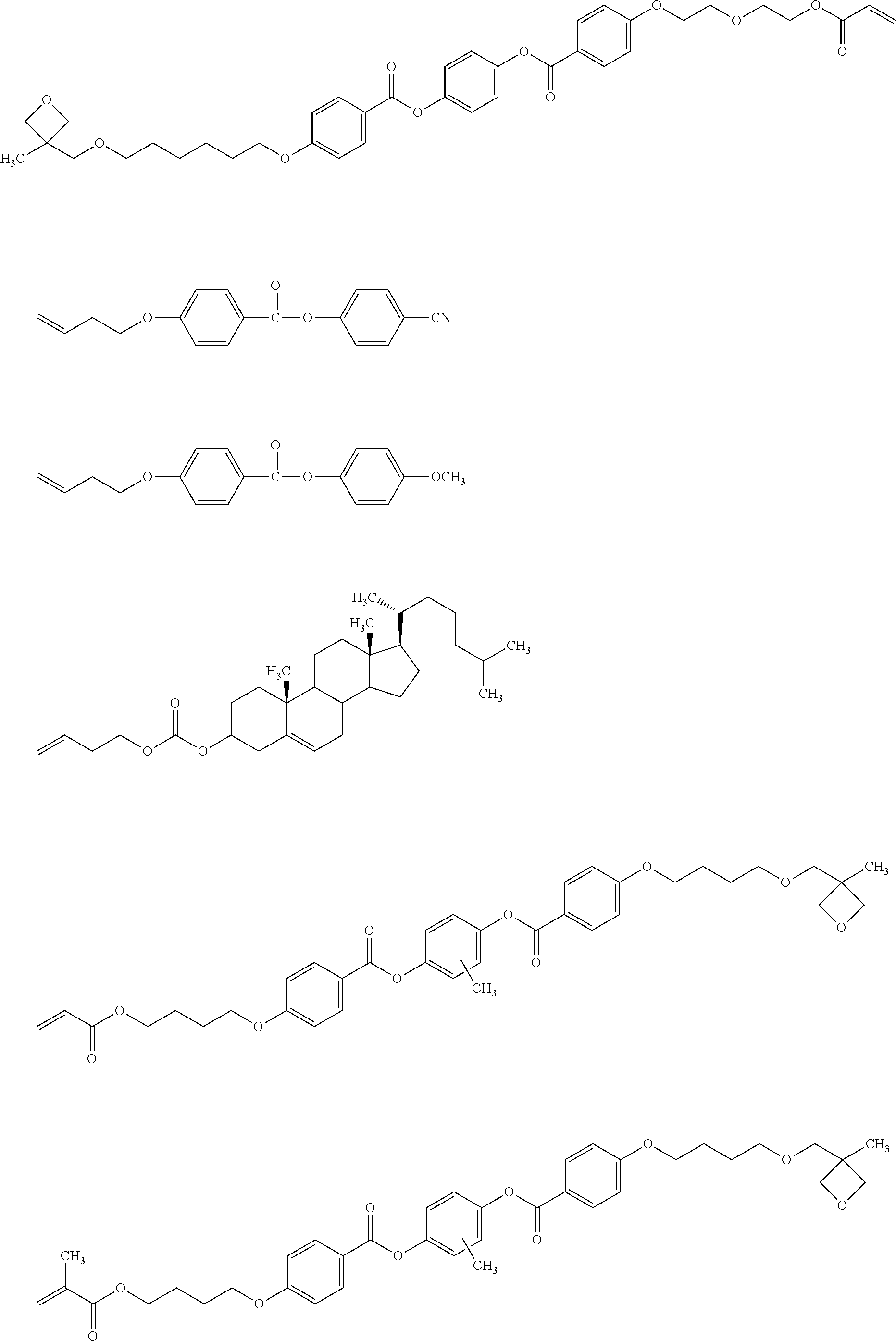

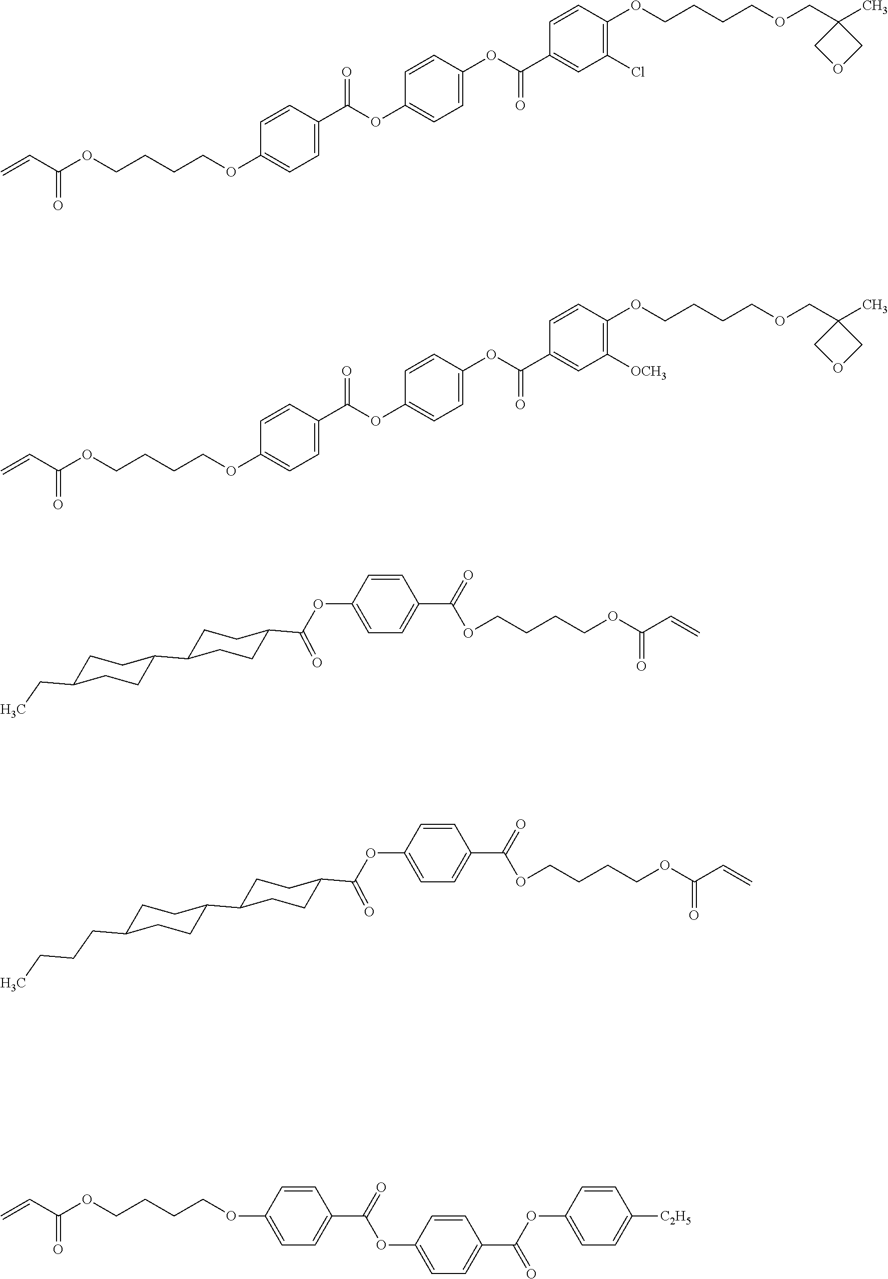

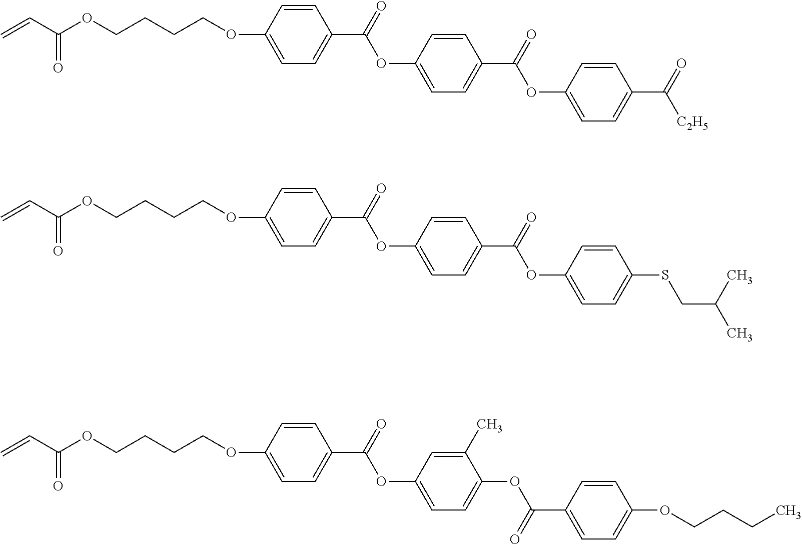

The liquid crystal composition may include one specific liquid crystal compound alone, or may include two or more specific liquid crystal compounds. A content of the specific liquid crystal compound is preferably 25% by mass or more with respect to the total solid content of the liquid crystal composition. In a case where the content of the specific liquid crystal compound is 25% by mass or more, a decorative film which has a small change in reflectance after molding is obtained. In addition, from the viewpoint of suppressing change in reflectance and change in tint after molding, with respect to the total solid content of the liquid crystal composition, the content of the specific liquid crystal compound is preferably 30% by mass or more, more preferably 40% by mass or more, still more preferably 60% by mass to 99% by mass, and particularly preferably 80% by mass to 98% by mass.

—Other Cholesteric Liquid Crystal Compound—

The liquid crystal composition may include other cholesteric liquid crystal compounds (hereinafter, also simply referred to as “other liquid crystal compounds”) other than the specific liquid crystal compound. Examples of other liquid crystal compounds include cholesteric liquid crystal compounds having no ethylenically unsaturated group and cyclic ether group, cholesteric liquid crystal compounds having two or more ethylenically unsaturated groups and no cyclic ether group, cholesteric liquid crystal compounds having two or more cyclic ether groups and no ethylenically unsaturated group, and cholesteric liquid crystal compounds having two or more ethylenically unsaturated groups and two or more cyclic ether groups. Among these, from the viewpoint of suppressing change in reflectance and change in tint after molding, the other liquid crystal compounds are preferably at least one compound selected from the group consisting of cholesteric liquid crystal compounds having no ethylenically unsaturated group and no cyclic ether group, cholesteric liquid crystal compounds having two or more ethylenically unsaturated groups and no cyclic ether group, or cholesteric liquid crystal compounds having two or more cyclic ether groups and no ethylenically unsaturated group, more preferably at least one compound selected from the group consisting of cholesteric liquid crystal compounds having no ethylenically unsaturated group and no cyclic ether group, cholesteric liquid crystal compounds having two ethylenically unsaturated groups and no cyclic ether group, or cholesteric liquid crystal compounds having two or more cyclic ether groups and no ethylenically unsaturated group, and particularly preferably at least one compound selected from the group consisting of cholesteric liquid crystal compounds having no ethylenically unsaturated group and no cyclic ether group or cholesteric liquid crystal compounds having two ethylenically unsaturated groups and no cyclic ether group.

As the other liquid crystal compounds, a known cholesteric liquid crystal compound can be used. As a rod-like liquid crystal compound in the other liquid crystal compounds, compounds described in “Makromol. Chem., vol. 190, p. 2255 (1989), Advanced Materials, vol. 5, p. 107 (1993)”, U.S. Pat. Nos. 4,683,327A, 5,622,648A, 5,770,107A, WO1995/022586A, WO1995/024455A, WO1997/000600A, WO1998/023580A, WO1998/052905A, JP1989-272551A (JP-H1-272551A), JP1994-16616A (JP-H6-16616A), JP1995-110469A (JP-H7-110469A), JP1999-80081A (JP-H11-80081A), and JP2001-328973A can be used. Furthermore, as the rod-like liquid crystal compound in the other liquid crystal compounds, for example, compounds described in JP1999-513019B (JP-H11-513019B) or JP2007-279688A can be preferably used. As the discotic liquid crystal compound in the other liquid crystal compounds, for example, compounds described in JP2007-108732A or JP2010-244038A can be preferably used.

The liquid crystal composition may include other liquid crystal compound alone, or may include two or more other liquid crystal compounds. From the viewpoint of suppressing change in reflectance and change in tint after molding, with respect to the total solid content of the liquid crystal composition, the content of the other liquid crystal compounds is preferably 70% by mass or less, more preferably 60% by mass or less, still more preferably 40% by mass or less, and particularly preferably 5% by mass or less. The lower limit value of the content of the other liquid crystal compounds is 0% by mass.

—Chiral Agent (Optically Active Compound)—

From the viewpoint of ease of forming a cholesteric liquid crystal layer and ease of adjusting the pitch of the helical structure, the liquid crystal composition preferably includes a chiral agent (that is, an optically active compound). The chiral agent has a function of inducing a helical structure in the cholesteric liquid crystal layer. Since a twist direction or helical pitch of the helix induced by the chiral agent is different depending on the liquid crystal compound, the chiral agent may be selected according to the purpose. The chiral agent is not particularly limited, and a known compound (for example, a chiral agent for twisted nematic (TN) and super-twisted nematic (STN), compound described in “Liquid Crystal Device Handbook”, Chapter 3, Section 4-3, p. 199, Japan Society for the Promotion of Science edited by the 142nd committee, 1989), and an isosorbide or isomannide derivative can be used. The chiral agent generally includes an asymmetric carbon atom, but an axially asymmetric compound or a surface asymmetric compound, which does not have the asymmetric carbon atom, can also be used as the chiral agent. Preferred examples of the axially asymmetric compound or the surface asymmetric compound include a binaphthyl compound, a helicene compound, and a paracyclophane compound.

From the viewpoint of suppressing change in reflectance after molding, the liquid crystal composition preferably includes, as the chiral agent, a chiral agent having a polymerizable group, and more preferably includes, as the chiral agent, a chiral agent having a polymerizable group and a chiral agent not having a polymerizable group. The polymerizable group is not particularly limited as long as the group is polymerizable, but from the viewpoint of reactivity and viewpoint of suppressing change in reflectance after molding, the polymerizable group is preferably an ethylenically unsaturated group or a cyclic ether group, and more preferably an ethylenically unsaturated group. Preferred aspects of the ethylenically unsaturated group and cyclic ether group in the chiral agent are the same as the preferred aspects of the ethylenically unsaturated group and cyclic ether group in the above-described specific liquid crystal compound, respectively.

In a case where the chiral agent has an ethylenically unsaturated group or a cyclic ether group, from the viewpoint of reactivity and viewpoint of suppressing change in reflectance after molding, it is preferable that the ethylenically unsaturated group or cyclic ether group included in the specific liquid crystal compound has the same type of the ethylenically unsaturated group or cyclic ether group included in the chiral agent (for example, an ethylenically unsaturated group, preferably a (meth)acryloxy group), and it is more preferable to be the same group.

From the viewpoint of reactivity and viewpoint of suppressing change in reflectance after molding, the chiral agent having a polymerizable group is preferably a chiral agent having two or more polymerizable groups, more preferably a chiral agent having two or more ethylenically unsaturated groups or a chiral agent having two or more cyclic ether groups, and particularly preferably a chiral agent having two or more ethylenically unsaturated groups.

The chiral agent may be a cholesteric liquid crystal compound.

As will be described later, in a case of controlling a size of the helical pitch of the cholesteric liquid crystal layer by irradiating the cholesteric liquid crystal layer with light during manufacturing of the cholesteric liquid crystal layer, the liquid crystal composition preferably includes a chiral agent (hereinafter, also referred to as a “photosensitive chiral agent”) capable of changing the helical pitch of the cholesteric liquid crystal layer in response to light. The photosensitive chiral agent is a compound in which the structure can be changed by absorbing light, thereby being capable of changing the helical pitch of the cholesteric liquid crystal layer. As such a compound, a compound which causes at least one of a photoisomerization reaction, a photodimerization reaction, or a photodegradation reaction is preferable. The compound which causes a photoisomerization reaction refers to a compound which causes stereoisomerization or structural isomerization by the action of light. Examples of the compound which causes a photoisomerization reaction include an azobenzene compound and a spiropyran compound. In addition, the compound which causes a photodimerization reaction refers to a compound which causes an addition reaction between two groups so as to be cyclized by irradiation with light. Examples of the compound which causes a photodimerization reaction include a cinnamic acid derivative, a coumarin derivative, a chalcone derivative, and a benzophenone derivative. In addition, the light is not particularly limited, and examples thereof include ultraviolet light, visible light, and infrared light.

Preferred examples of the photosensitive chiral agent include a chiral agent represented by Formula (CH1). The chiral agent represented by Formula (CH1) can change the alignment structure such as the helical pitch (for example, helical cycle and twist cycle) of a cholesteric liquid crystal layer according to the amount of light during irradiation with the light.

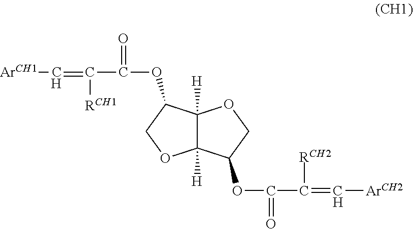

In Formula (CH1), Ar^{CH1} and Ar^{CH2} each independently represent an aryl group or a heteroaromatic ring group, and R^{CH1} and R^{CH2} each independently represent a hydrogen atom or a cyano group.

In Formula (CH1), it is preferable that Ar^{CH1} and Ar^{CH2} are each independently an aryl group. The aryl group of Ar^{CH1} and Ar^{CH2} in Formula (CH1) preferably has a total carbon number of 6 to 40, and more preferably has a total carbon number of 6 to 30. The aryl group may have a substituent. As the substituent, for example, a halogen atom, an alkyl group, an alkenyl group, an alkynyl group, an alkoxy group, a hydroxy group, an acyl group, an alkoxycarbonyl group, an aryloxycarbonyl group, an acyloxy group, a carboxy group, a cyano group, or a heterocyclic group is preferable, and a halogen atom, an alkyl group, an alkenyl group, an alkoxy group, a hydroxy group, an acyloxy group, an alkoxycarbonyl group, or an aryloxycarbonyl group is more preferable.

As Ar^{CH1} and Ar^{CH2}, an aryl group represented by Formula (CH2) or Formula (CH3) is preferable.

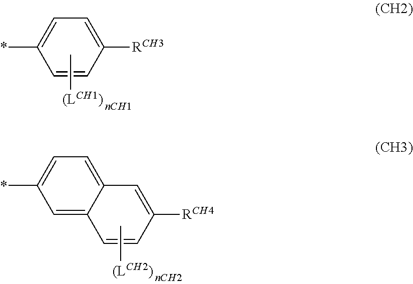

In Formula (CH2) and Formula (CH3), R^{CH3} and R^{CH4} each independently represent a hydrogen atom, a halogen atom, an alkyl group, an alkenyl group, an alkynyl group, an aryl group, a heterocyclic group, an alkoxy group, a hydroxy group, an acyl group, an alkoxycarbonyl group, an aryloxycarbonyl group, an acyloxy group, a carboxy group, or a cyano group, L^{CH1} and L^{CH2} each independently represent a halogen atom, an alkyl group, an alkoxy group, or a hydroxy group, nCH1 represents an integer of 0 to 4, nCH2 represents an integer of 0 to 6, and * represents a bonding position with C forming an ethylene unsaturated bond in Formula (CH1).

In Formula (CH2) and Formula (CH3), R^{CH3} and R^{CH4} are each independently preferably a hydrogen atom, a halogen atom, an alkyl group, an alkenyl group, an aryl group, an alkoxy group, a hydroxy group, an alkoxycarbonyl group, an aryloxycarbonyl group, or an acyloxy group, more preferably an alkoxy group, a hydroxy group, or an acyloxy group, and particularly preferably an alkoxy group.

In Formula (CH2) and Formula (CH3), L^{CH1} and L^{CH2} are each independently preferably an alkoxy group having 1 to 10 carbon atoms, or a hydroxy group.

nCH1 in Formula (CH2) is preferably 0 or 1.

nCH2 in Formula (CH3) is preferably 0 or 1.

The heteroaromatic ring group of Ar^{CH1} and Ar^{CH2} in Formula (CH1) preferably has a total carbon number of 4 to 40, and more preferably has a total carbon number of 4 to 30. The heteroaromatic ring group may have a substituent. As the substituent, for example, a halogen atom, an alkyl group, an alkenyl group, an alkynyl group, an aryl group, an alkoxy group, a hydroxy group, an acyl group, an alkoxycarbonyl group, an aryloxycarbonyl group, an acyloxy group, or a cyano group is preferable, and a halogen atom, an alkyl group, an alkenyl group, an aryl group, an alkoxy group, or an acyloxy group is more preferable. As the heteroaromatic ring group, a pyridyl group, a pyrimidinyl group, a furyl group, or a benzofuranyl group is preferable, and a pyridyl group or a pyrimidinyl group is more preferable.

In Formula (CH1), it is preferable that R^{CH1} and R^{CH2} are each independently a hydrogen atom.

The liquid crystal composition may include one chiral agent alone, or may include two or more chiral agents. A content of the chiral agent can be appropriately selected according to a desired pitch of the structure or helical structure of the specific liquid crystal compound to be used. From the viewpoint of ease of forming a cholesteric liquid crystal layer and ease of adjusting the pitch of the helical structure, and viewpoint of suppressing change in reflectance after molding, the content of the chiral agent is preferably 1% by mass to 20% by mass, more preferably 2% by mass to 15% by mass, and particularly preferably 3% by mass to 10% by mass with respect to the total solid content of the liquid crystal composition.

In a case where the liquid crystal composition contains a chiral agent having a polymerizable group as the chiral agent, from the viewpoint of suppressing change in reflectance after molding, the content of the chiral agent having a polymerizable group is preferably 0.2% by mass to 15% by mass, more preferably 0.5% by mass to 10% by mass, still more preferably 1% by mass to 8% by mass, and particularly preferably 1.5% by mass to 5% by mass with respect to the total solid content of the liquid crystal composition.

In a case where the liquid crystal composition contains a chiral agent not having a polymerizable group as the chiral agent, from the viewpoint of suppressing change in reflectance after molding, the content of the chiral agent not having a polymerizable group is preferably 0.2% by mass to 20% by mass, more preferably 0.5% by mass to 15% by mass, and particularly preferably 1.5% by mass to 10% by mass with respect to the total solid content of the liquid crystal composition.

In addition, the pitch of the helical structure of the cholesteric liquid crystal in the cholesteric liquid crystal layer, and the selective reflection wavelength and its range described later can be easily changed not only by adjusting the type of the liquid crystal compound used but also by adjusting the content of the chiral agent. Although it cannot be said unconditionally, in a case where the content of the chiral agent in the liquid crystal composition is doubled, the above-described pitch may be halved and the center value of the above-described selective reflection wavelength may be halved.

—Polymerization Initiator—

The liquid crystal composition preferably includes a polymerization initiator, and more preferably includes a photopolymerization initiator.

In a case where the liquid crystal composition includes a cholesteric liquid crystal compound having one ethylenically unsaturated group, from the viewpoint of suppressing change in reflectance and change in tint after molding, the above-described liquid crystal composition preferably includes a radical polymerization initiator, and more preferably includes a photoradical polymerization initiator.

In a case where the liquid crystal composition includes a cholesteric liquid crystal compound having one cyclic ether group, from the viewpoint of suppressing change in reflectance and change in tint after molding, the above-described liquid crystal composition preferably includes a cationic polymerization initiator, and more preferably includes a photocationic polymerization initiator.

It is preferable that the liquid crystal composition includes only one of the radical polymerization initiator or the cationic polymerization initiator as the polymerization initiator.

As the polymerization initiator, a known polymerization initiator can be used. In addition, the polymerization initiator is preferably a photopolymerization initiator capable of initiating a polymerization reaction by ultraviolet irradiation. Examples of the photopolymerization initiator include α-carbonyl compounds (described in U.S. Pat. Nos. 2,367,661A and 2,367,670A), acyloin ether compounds (described in U.S. Pat. No. 2,448,828A), α-hydrocarbon-substituted aromatic acyloin compounds (described in U.S. Pat. No. 2,722,6512A), polynuclear quinone compounds (described in U.S. Pat. Nos. 3,046,127A and 2,951,6758A), combinations of triarylimidazole dimer and p-aminophenyl ketone (described in U.S. Pat. No. 3,549,5367A), acridine compounds and phenazine compounds (described in JP1985-105667A (JP-S60-105667A) and U.S. Pat. No. 4,239,6850A), and oxadiazole compounds (described in U.S. Pat. No. 4,212,970A).

As the photoradical polymerization initiator, a known photoradical polymerization initiator can be used. Preferred examples of the photoradical polymerization initiator include α-hydroxyalkylphenone compounds, α-aminoalkylphenone compounds, and acylphosphine oxide compounds.

As the photocationic polymerization initiator, a known photocationic polymerization initiator can be used. Preferred examples of the photocationic polymerization initiator include iodonium salt compounds and sulfonium salt compounds.

The liquid crystal composition may include one polymerization initiator alone, or may include two or more polymerization initiators. A content of the polymerization initiator can be appropriately selected according to a desired pitch of the structure or helical structure of the specific liquid crystal compound to be used. From the viewpoint of ease of forming a cholesteric liquid crystal layer, ease of adjusting the pitch of the helical structure, a polymerization rate, and the strength of the cholesteric liquid crystal layer, the content of the polymerization initiator is preferably 0.05% by mass to 10% by mass, more preferably 0.05% by mass to 5% by mass, still more preferably 0.1% by mass to 2% by mass, and particularly preferably 0.2% by mass to 1% by mass with respect to the total solid content of the liquid crystal composition.

—Crosslinking Agent—

The liquid crystal composition may include a crosslinking agent in order to improve the strength and durability of the cholesteric liquid crystal layer after curing. As the crosslinking agent, for example, a crosslinking agent which cures with ultraviolet rays, heat, or humidity can be suitably used. The crosslinking agent is not particularly limited and can be appropriately selected according to the purpose, and examples thereof include polyfunctional acrylate compounds such as trimethylolpropane tri(meth)acrylate and pentaerythritol tri(meth)acrylate; epoxy compounds such as glycidyl (meth)acrylate and ethylene glycol diglycidyl ether; aziridine compounds such as 2,2-bishydroxymethylbutanol-tris[3-(1-aziridinyl)propionate] and 4,4-bis(ethyleneiminocarbonylamino)diphenylmethane; isocyanate compounds such as hexamethylene diisocyanate and biuret-type isocyanate; polyoxazoline compounds having an oxazoline group in the side chain; and alkoxysilane compounds such as vinyltrimethoxysilane and N-(2-aminoethyl) 3-aminopropyltrimethoxysilane. In addition, a known catalyst can be used depending on reactivity of the crosslinking agent, and in addition to improving the strength and durability of the cholesteric liquid crystal layer, productivity can be improved.

The liquid crystal composition may include one crosslinking agent alone, or may include two or more crosslinking agents. From the viewpoint of the strength and durability of the cholesteric liquid crystal layer, a content of the crosslinking agent is preferably 1% by mass to 20% by mass and more preferably 3% by mass to 15% by mass with respect to the total solid content of the liquid crystal composition.

—Polyfunctional Polymerizable Compound—

From the viewpoint of suppressing the change in reflectance after molding, the liquid crystal composition preferably includes a polyfunctional polymerizable compound and more preferably includes a polyfunctional polymerizable compound having the same type of polymerizable group. Examples of the polyfunctional polymerizable compound include, in the above-described other cholesteric liquid crystal compounds, cholesteric liquid crystal compounds having two or more ethylenically unsaturated groups and no cyclic ether group; cholesteric liquid crystal compounds having two or more cyclic ether groups and no ethylenically unsaturated group; cholesteric liquid crystal compounds having two or more ethylenically unsaturated groups and two or more cyclic ether groups; chiral agents having two or more polymerizable groups in the above-described chiral agent; and the above-described crosslinking agent.

In the liquid crystal composition, as the polyfunctional polymerizable compound, at least one compound selected from the group consisting of cholesteric liquid crystal compounds two or more ethylenically unsaturated groups and no cyclic ether group, cholesteric liquid crystal compounds having two or more cyclic ether groups and no ethylenically unsaturated group, and chiral agents having two or more polymerizable groups is preferable, and chiral agents having two or more polymerizable groups are more preferable.

The liquid crystal composition may include one polyfunctional polymerizable compound alone, or may include two or more polyfunctional polymerizable compounds. From the viewpoint of suppressing change in reflectance after molding, a content of the polyfunctional polymerizable compound is preferably 0.5% by mass to 70% by mass, more preferably 1% by mass to 50% by mass, still more preferably 1.5% by mass to 20% by mass, and particularly preferably 2% by mass to 10% by mass with respect to the total solid content of the liquid crystal composition.

—Other Additives—

The liquid crystal composition may include other additives other than the above-described components as necessary. As other additives, a known additive can be used, and examples thereof include a surfactant, a polymerization inhibitor, an antioxidant, a horizontal alignment agent, an ultraviolet absorber, a light stabilizer, a colorant, and metal oxide particles.

In addition, the liquid crystal composition may include a solvent. The solvent is not particularly limited and can be appropriately selected according to the purpose, but an organic solvent is preferably used. The organic solvent is not particularly limited and can be appropriately selected according to the purpose, and examples thereof include ketones (for example, methyl ethyl ketone and methyl isobutyl ketone), alkyl halides, amides, sulfoxides, heterocyclic compounds, hydrocarbons, esters, and ethers. The solvent may be used singly, or two or more kinds thereof may be used in combination. Among these, in consideration of environmental load, ketones are particularly preferable. In addition, the above-described component may function as the solvent.

A content of the solvent in the liquid crystal composition is not particularly limited, and may be adjusted to a content of the solvent such that a desired coatability is obtained. A content of solid contents with respect to the total mass of the liquid crystal composition is not particularly limited, but is preferably 1% by mass to 90% by mass, more preferably 5% by mass to 80% by mass, and particularly preferably 10% by mass to 80% by mass. The content of the solvent in the liquid crystal composition during curing in a case of forming the cholesteric liquid crystal layer is preferably 5% by mass or less, more preferably 3% by mass or less, still more preferably 2% by mass or less, and particularly preferably 1% by mass or less with respect to the total solid content of the liquid crystal composition. In addition, the content of the solvent in the cholesteric liquid crystal layer obtained by curing the liquid crystal composition is preferably 5% by mass or less, more preferably 3% by mass or less, still more preferably 2% by mass or less, and particularly preferably 1% by mass or less with respect to the total mass of the cholesteric liquid crystal layer.

—Coating and Curing of Liquid Crystal Composition—

In the formation of the cholesteric liquid crystal layer, for example, the liquid crystal composition is used by being applied to an object (for example, the above-described base material, and an alignment layer described later). After the liquid crystal composition is made into a solution with a solvent or made into a liquid such as a molten liquid by heating, the liquid crystal composition can be applied, for example, by an appropriate method such as a roll coating method, a gravure printing method, and a spin coating method. The liquid crystal composition can also be applied by various methods such as a wire bar coating method, an extrusion coating method, a direct gravure coating method, a reverse gravure coating method, and a die-coating method. In addition, using an inkjet device, the liquid crystal composition can be jetted from a nozzle to form a coating film (referring to a film-like liquid crystal composition formed by coating).

After the application of the liquid crystal composition, the cholesteric liquid crystal layer is formed by curing the liquid crystal composition. By curing the liquid crystal composition, the alignment state of molecules of the liquid crystal compound (for example, the above-described specific liquid crystal compound) is maintained and fixed. The curing of the liquid crystal composition is preferably performed by a polymerization reaction of polymerizable groups (for example, ethylenically unsaturated groups or cyclic ether groups) included in the liquid crystal compound. In a case of using the solvent as a component of the liquid crystal composition, after the application of the liquid crystal composition and before the polymerization reaction for curing, it is preferable that the coating film is dried by a known method. For example, the coating film may be dried by allowing to stand or by heating. It is sufficient that the liquid crystal compound in the liquid crystal composition is aligned after the application and drying of the liquid crystal composition.

—Layer Configuration of Cholesteric Liquid Crystal Layer—

From the viewpoint of suppressing change in reflectance after molding, the decorative film according to the embodiment of the present disclosure preferably has two or more cholesteric liquid crystal layers. In addition, compositions of the two or more cholesteric liquid crystal layers may be the same or different from each other. In a case where the decorative film according to the embodiment of the present disclosure has two or more cholesteric liquid crystal layers, it is sufficient that the decorative film according to the embodiment of the present disclosure has at least one layer formed by curing a liquid crystal composition which includes, with respect to the total solid content of the liquid crystal composition, 25% by mass or more of the cholesteric liquid crystal compound having one ethylenically unsaturated group or one cyclic ether group (that is, the specific liquid crystal compound). From the viewpoint of suppressing change in reflectance after molding, it is preferable that all the two or more cholesteric liquid crystal layers are a layer formed by curing a liquid crystal composition which includes, with respect to the total solid content of the liquid crystal composition, 25% by mass or more of the cholesteric liquid crystal compound having one ethylenically unsaturated group or one cyclic ether group.

In addition, for example, in a case where the decorative film according to the embodiment of the present disclosure has two cholesteric liquid crystal layers, from the viewpoint of suppressing change in reflectance after molding, it is preferable to have the cholesteric liquid crystal layer on each surface of the above-described base material.

<<Selective Reflectivity of Reflective Layer>>

The reflective layer preferably has a central wavelength of a selective reflection wavelength in a range of 300 nm or more and 1,500 nm or less. In the present disclosure, the “central wavelength of the selective reflection wavelength” refers to, in a case where the minimum value and the local minimum value of light transmittance in a target object (for example, the reflective layer) are defined as Tₘᵢₙ (unit: %), an average value of two wavelengths showing half-value transmittance T_{1/2} (unit: %) represented by the following expression. However, a first wavelength of the two wavelengths is the maximum wavelength in a wavelength range including a wavelength shorter than the wavelength indicating Tₘᵢₙ, and a second wavelength of the two wavelengths in the minimum wavelength in the wavelength range including a wavelength longer than the wavelength indicating Tₘᵢₙ. The transmittance is measured by a spectrophotometer (for example, spectrophotometer UV-2100 manufactured by Shimadzu Corporation). The central wavelength of the selective reflection wavelength may be included in a range of 380 nm or more and 780 nm or less, or in a range of more than 780 nm and 1,500 nm or less.

Expression for calculating half-value transmittance:

T_{1/2}=100−(100−Tₘᵢₙ)/2

The reflective layer preferably has a maximal reflection wavelength in a wavelength range of 380 nm to 1,500 nm. From the viewpoint of use for the decorative film, the wavelength range including the maximal reflection wavelength is preferably 380 nm to 1,200 nm, more preferably 400 nm to 1,000 nm, and particularly preferably 420 nm to 900 nm.

From the viewpoint of strength and durability, a thickness of the reflective layer is preferably 0.2 μm to 150 μm, more preferably 0.5 μm to 100 μm, still more preferably 1 μm to 50 μm, and particularly preferably 1 μm to 10 μm.

<Alignment Layer>

The decorative film according to the embodiment of the present disclosure may have an alignment layer which is in contact with the cholesteric liquid crystal layer. The alignment layer is used for aligning the molecules of the liquid crystal compound in the liquid crystal composition in a case of forming a layer including the liquid crystal compound (hereinafter, also referred to as a “liquid crystal layer”). For example, since the alignment layer is used in the case of forming the liquid crystal layer, in a decorative film which does not include the liquid crystal layer, the alignment layer may or may not be included.

For example, the alignment layer can be provided by a rubbing treatment of an organic compound (preferably a polymer), an oblique vapor deposition of an inorganic compound (for example, SiO₂), or a formation of a layer having a microgroove. Furthermore, an alignment layer in which an alignment function occurs by application of an electric field, application of a magnetic field, or light irradiation has also been known. Depending on a material of the underlayer such as the support and the liquid crystal layer, the alignment layer may not be provided and the underlayer may be subjected to a direct alignment treatment (for example, rubbing treatment) to function as an alignment layer. Polyethylene terephthalate (PET) can be mentioned as an example of such a support as the underlayer. In addition, in a case where a layer (hereinafter, referred to as an “upper layer” in this paragraph) is directly laminated on the liquid crystal layer, in some cases, the liquid crystal layer as the underlayer behaves as the alignment layer and the liquid crystal compound for forming the upper layer can be aligned. In such a case, the liquid crystal compound in the upper layer can be aligned without providing the alignment layer or performing a special alignment treatment (for example, rubbing treatment).

Hereinafter, as a preferred example of the alignment layer, a rubbing-treated alignment layer and a photoalignment layer will be described.

<<Rubbing-Treated alignment Layer>>

The rubbing-treated alignment layer is an alignment layer to which aligning properties are imparted by a rubbing treatment. Examples of a polymer which can be used in the rubbing-treated alignment layer include a methacrylate-based copolymer, a styrene-based copolymer, polyolefin, polyvinyl alcohol and modified polyvinyl alcohol, poly(N-methylol acrylamide), polyester, polyimide, a vinyl acetate copolymer, carboxymethyl cellulose, and polycarbonate, which are described in paragraph 0022 of JP1996-338913A (JP-H8-338913A). A silane coupling agent can be used as the polymer. As the polymer which can be used in the rubbing-treated alignment layer, a water-soluble polymer (for example, poly(N-methylol acrylamide), carboxymethyl cellulose, gelatin, polyvinyl alcohol, and modified polyvinyl alcohol) is preferable, gelatin, polyvinyl alcohol, or modified polyvinyl alcohol is more preferable, and polyvinyl alcohol or modified polyvinyl alcohol is particularly preferable.

In a method of aligning the liquid crystal compound using the rubbing-treated alignment layer, for example, the molecules of the liquid crystal compound are aligned by coating a rubbing-treated surface of the rubbing-treated alignment layer with a composition for forming a cholesteric liquid crystal layer (one aspect of the liquid crystal composition). Thereafter, as necessary, by reacting the polymer included in the alignment layer with a polyfunctional monomer included in the cholesteric liquid crystal layer, or by crosslinking polymer included in the alignment layer using a crosslinking agent, the cholesteric liquid crystal layer can be formed. A film thickness of the alignment layer is preferably in a range of 0.1 μm to 10 μm.

—Rubbing Treatment—

The surface of the alignment layer, the support, or other layers, to be coated with the composition for forming a cholesteric liquid crystal layer, may be subjected to a rubbing treatment as necessary. The rubbing treatment can be generally performed by rubbing a surface of a film containing a polymer as a main component with paper or cloth in a certain direction. The general method of the rubbing treatment is described in, for example, “Handbook of Liquid crystals” (published by Maruzen, Oct. 30, 2000).

As a method of changing a rubbing density, the method described in “Handbook of Liquid crystals” (published by Maruzen) can be used. The rubbing density (L) is quantified by Expression (A).

L=Nl(1 +2πrn/60v) Expression (A)

In Expression (A), N is the number of times of rubbing, π is the pi, l is a contact length of a rubbing roller, r is a radius of the roller, n is a rotation speed (revolutions per minute: rpm) of the roller, and v is a stage moving speed (speed per second).

In order to increase the rubbing density, it is sufficient that the number of times of rubbing is increased, the contact length of the rubbing roller is increased, the radius of the roller is increased, the rotation speed of the roller is increased, or the stage moving speed is decreased. On the other hand, in order to decrease the rubbing density, it is sufficient that the reverse is carried out. In addition, with regard to conditions for the rubbing treatment, the description in JP4052558B can be referred to.

<<Photoalignment Layer>>

The photoalignment layer is an alignment layer to which aligning properties are imparted by light irradiation. A photo-alignment material used for the photoalignment layer is described in many references. Preferred examples of the photo-alignment material include azo compounds described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B; aromatic ester compounds described in JP2002-229039A; maleimide and/or alkenyl-substituted nadiimide compounds having a photo alignment unit, described in JP2002-265541A and JP2002-317013A; photo-crosslinkable silane derivatives described in JP4205195B and JP4205198B; and photo-crosslinkable polyimides, polyamides, or esters described in JP2003-520878A, JP2004-529220A, and JP4162850B. Azo compounds or photo-crosslinkable polyimides, polyamides, or esters are particularly preferable.

For example, the photoalignment layer is manufactured by subjecting a layer formed of the above-described material to an irradiation of linearly polarized light or non-polarized light. In the present disclosure, the “irradiation of linearly polarized light” is an operation for causing a photo-reaction of the photo-alignment material. The wavelength of the light used depends on the photo-alignment material used, and is not particularly limited as long as a wavelength is necessary for the photo-reaction. The peak wavelength of the light used for light irradiation is preferably 200 nm to 700 nm and the light is more preferably ultraviolet light having a peak wavelength of 400 nm or less.

Examples of a light source used for light irradiation include commonly used light sources, for example, lamps (for example, a tungsten lamp, a halogen lamp, a xenon lamp, a xenon flash lamp, a mercury lamp, a mercury-xenon lamp, and a carbon arc lamp), various lasers (for example, semiconductor laser, helium neon laser, argon ion laser, helium cadmium laser, and yttrium aluminum garnet (YAG) laser), light emitting diodes, and cathode ray tube.

As a method for obtaining the linearly polarized light, a method of using a polarizing plate (for example, iodine polarizing plate, dichroic coloring agent polarizing plate, and wire grid polarizing plate), a method of using a prismatic element (for example, Glan-Thomson prism) and a reflective type polarizer using Brewster's angle, or a method of using light emitted from a polarized laser light source can be adopted. In addition, by using a filter and a wavelength conversion element, only light having a required wavelength may be irradiated selectively.

In a case where the irradiated light is the linearly polarized light, a method of irradiating light perpendicularly or obliquely to the upper surface or the lower surface of the alignment layer is adopted. The incidence angle of the light varies depending on the photo-alignment material, but is preferably 0° to 90° (perpendicular) and more preferably 40° to 90°. In a case where non-polarized light is used, the non-polarized light is obliquely irradiated to the upper surface or the lower surface of the alignment layer. The incidence angle of the non-polarized light is preferably 10° to 80°, more preferably 20° to 60°, and particularly preferably 30° to 50°. The irradiation time is preferably 1 minute to 60 minutes and more preferably 1 minute to 10 minutes.

<Resin Layer>

The decorative film according to the embodiment of the present disclosure preferably includes a resin layer between the base material and the reflective layer. For example, in a case where a pressure is applied to the reflective layer to impart an uneven structure, by deforming the resin layer, it is easier for the reflective layer to follow unevenness used as a mold.

A thickness of the resin layer is preferably 0.2 μm to 100 μm, more preferably 0.5 μm to 70 μm, and still more preferably 1.0 μm to 50 μm.

An elastic modulus of the resin layer at 25° C. is preferably 0.000001 GPa to 3 GPa, more preferably 0.0001 to 1 GPa, and still more preferably 0.00001 to 0.5 GPa. The elastic modulus is measured by a nanoindenter device (for example, Nano Indenter G200, manufactured by KLA Corporation).

The resin layer preferably includes a binder resin as a main component. The binder resin is not limited, and a known resin can be applied. From the viewpoint of obtaining a desired color, as the binder resin, a transparent resin is preferable, and specifically, a resin having a total light transmittance of 80% or more is preferable. The total light transmittance can be measured by a spectrophotometer (for example, spectrophotometer UV-2100 manufactured by Shimadzu Corporation).

The binder resin is not limited, and a known resin can be applied. Examples of the binder resin include acrylic resins, silicone resins, polyester, urethane resins, and polyolefin. The binder resin may be a homopolymer of a specific monomer or a copolymer of the specific monomer and another monomer.

The binder resin may be used alone or in combination of two or more kinds thereof. From the viewpoint of molding processability, a content of the binder resin in the resin layer is preferably 5% by mass to 70% by mass, more preferably 10% by mass to 60% by mass, and particularly preferably 20% by mass to 60% by mass with respect to the total mass of the resin layer.

A known pressure sensitive adhesive or adhesive can also be used as the resin layer.

<<Pressure Sensitive Adhesive>>

Examples of the pressure sensitive adhesive include an acrylic pressure sensitive adhesive, a rubber-based pressure sensitive adhesive, and a silicone-based pressure sensitive adhesive. In addition, examples of the pressure sensitive adhesive include acrylic pressure sensitive adhesives, ultraviolet (UV) curable pressure sensitive adhesives, and silicone-based pressure sensitive adhesives described in “Chapters 2 of “Characterization evaluation of release paper, release film, and adhesive tape, and control technique thereof”, 2004, Information Mechanism”. The acrylic pressure sensitive adhesive in the present disclosure refers to a pressure sensitive adhesive including a polymer (that is, a (meth)acrylic polymer) of a (meth)acrylic monomer. In a case where the resin layer contains a pressure sensitive adhesive, the resin layer may further contain a viscosity imparting agent.

<<Adhesive>>

Examples of the adhesive include a urethane resin adhesive, a polyester adhesive, an acrylic resin adhesive, an ethylene vinyl acetate resin adhesive, a polyvinyl alcohol adhesive, a polyamide adhesive, and a silicone adhesive. From the viewpoint of higher adhesive force, a urethane resin adhesive or a silicone adhesive is preferable.

<<Method for Forming Resin Layer>>

A method for forming the resin layer is not limited. The resin layer can be formed, for example, by using a composition for forming the resin layer. The composition for forming the resin layer can be prepared, for example, by mixing raw materials of the resin layer. As a method for applying the composition for forming the resin layer, for example, the same method as the method for applying the liquid crystal composition can be used.

<<Additive>>

The resin layer may contain additives as necessary, in addition to the above-described components. The additive is not limited, and a known additive can be applied. Examples of the additive include surfactants described in paragraph 0017 of JP4502784B and paragraphs 0060 to 0071 of JP2009-237362A, thermal polymerization inhibitor described in paragraph 0018 of JP4502784B (also referred to as a polymerization inhibitor; preferred examples thereof include phenothiazine), and other additives described in paragraphs 0058 to 0071 of JP2000-310706.

<Colored layer>

The decorative film according to the embodiment of the present disclosure preferably includes a colored layer. In addition, in a certain embodiment, the decorative film is preferably a decorative film for viewing the colored layer through the cholesteric liquid crystal layer. The colored layer may be a colored (that is, not colorless and transparent) layer. The colored layer is preferably an opaque colored layer (preferably, a colored layer having a total light transmittance of 10% or less). In addition, the color of the colored layer may be black, gray, white, red, orange, yellow, green, blue, or violet. A black-colored layer is preferable from the viewpoint that the intensity of the reflected light is low and the change in color is more emphasized. A white-colored layer is preferable from the viewpoint light transmitted through the reflective layer is reflected by the colored layer and a change in tint using a complementary color is obtained. For example, in a case where the reflective layer selectively reflects green light, it is possible to express a tint using a magenta color which is a complementary color thereof

In addition, the colored layer may be a layer formed by curing a polymerizable compound, or may be a layer including a polymerizable compound and a polymerization initiator. From the viewpoint of storability and adhesiveness between the colored layer and other layers, the colored layer is preferably a layer formed by curing a polymerizable compound and more preferably a layer formed by curing at least a bifunctional or trifunctional polymerizable compound which has at least one partial structure selected from the group consisting of a urethane bond and an alkyleneoxy group having 2 or 3 carbon atoms.

<<Colorant>>

The colored layer preferably includes a colorant from the viewpoint of visibility, and more preferably includes a pigment as a colorant from the viewpoint of durability. The colorant is not particularly limited, and a colorant having a target color tone can be appropriately selected and used. Examples of the colorant include a pigment and a dye, and a pigment is preferable.

In addition, the pigment is preferably a pigment having a particle shape. As the pigment, various inorganic pigments or organic pigments known in the related art can be used.

Examples of the inorganic pigment include inorganic pigments described in paragraph 0015 and paragraph 0114 of JP2005-7765A. Specific examples of the inorganic pigment include white pigments (for example, titanium dioxide, zinc oxide, lithopone, light calcium carbonate, white carbon, aluminum oxide, aluminum hydroxide, and barium sulfate) and black pigments (for example, carbon black, titanium black, titanium carbon, iron oxide, and graphite). For example, known chromatic pigments such as iron oxide, barium yellow, cadmium red, and chrome yellow can also be used.

Examples of the organic pigment include organic pigments described in paragraph 0093 of JP2009-256572A. Specific examples of the organic pigment include red pigments such as C. I. Pigment Red 177, 179, 224, 242, 254, 255, and 264, yellow pigments such as C. I. Pigment Yellow 138, 139, 150, 180, and 185, orange pigments such as C. I. Pigment Orange 36, 38, and 71, green pigments such as C. I. Pigment Green 7, 36, and 58, blue pigments such as C. I. Pigment Blue 15:6, and violet pigments such as C. I. Pigment Violet 23.

In addition, as the pigment, the colored layer may include particles of a pigment (so-called bright pigment) having a light-transmitting property and light-reflecting property. In a case where a method for forming the colored layer includes a step of exposing the colored layer, the bright pigment is preferably used in a range that does not hinder the curing by exposure.

The colorant may be used singly, or two or more kinds thereof may be used in combination. In addition, particles of the inorganic pigment and particles of the organic pigment may be used in combination. From the viewpoint of developing the target color tone (for example, suppressing whitening) and maintaining shape-following property of the colored layer to the mold, a content of the colorant in the colored layer is preferably 1% by mass to 50% by mass, more preferably 5% by mass to 50% by mass, and still more preferably 10% by mass to 40% by mass with respect to the total mass of the colored layer. Here, the “whitening” in the present disclosure means that the colored layer changes so as to exhibit a whitish tint with a matt tone.

<<Polymerizable Compound>>

The colored layer used in the present disclosure may include a polymerizable compound. The polymerizable compound is a compound having a polymerizable group.

Examples of a polymerizable group include an ethylenically unsaturated group and an epoxy group, and from the viewpoint of curing properties, an ethylenically unsaturated group is preferable and a (meth)acryloxy group is more preferable. In addition, as the polymerizable group, a radically polymerizable group is preferable.

As the polymerizable compound, a bifunctional or trifunctional polymerizable compound (hereinafter, also referred to as a “specific polymerizable compound”) having at least one partial structure selected from the group consisting of a urethane bond, a urea bond, an alkyleneoxy group having 2 or 3 carbon atoms, and a hydrocarbon group having 6 to 12 carbon atoms is preferable, and a compound including a urethane bond in the partial structure is more preferable.

—Bifunctional or Trifunctional Polymerizable Compound having Urethane Bond—

As the bifunctional or trifunctional polymerizable compound (hereinafter, also referred to as a “specific polymerizable compound 1”) having a urethane bond, a urethane oligomer is preferable. A nitrogen atom in the urethane bond may be two-substituted (one of the groups on the nitrogen atom is a hydrogen atom) or three-substituted. In addition, the specific polymerizable compound 1 preferably has a urethane resin chain.

As the urethane oligomer, urethane (meth)acrylate oligomer is preferable. Examples of the urethane (meth)acrylate oligomer include an aliphatic urethane (meth)acrylate and an aromatic urethane (meth)acrylate. For details, the reference can be made to Oligomer Handbook (edited by Junji Furukawa, The Chemical Daily Co., Ltd.), and the urethane oligomer described therein can be appropriately selected according to the purpose and used for forming the colored layer.

A molecular weight of the urethane oligomer which is one of the specific polymerizable compounds 1 is preferably 800 to 2,000 and more preferably 1,000 to 2,000.

As the urethane (meth)acrylate oligomer which is one of the specific polymerizable compounds 1, a commercially available product may be used. Examples of the commercially available product of the urethane (meth)acrylate oligomer include U-2PPA and UA-122P manufactured by Shin-Nakamura Chemical Co., Ltd.; CN964A85, CN964, CN959, CN962, CN963J85, CN965, CN982B88, CN981, CN983, CN991, CN991NS, CN996, CN996NS, CN9002, CN9007, CN9178, and CN9893 manufactured by Sartomer Japan Inc.; and EBECRYL230, EBECRYL270, EBECRYL284, EBECRYL4858, EBECRYL210, EBECRYL8402, EBECRYL8804, and EBECRYL8800-20R manufactured by DAICEL-ALLNEX LTD. (above, product name). Note that, “EBECRYL” is a registered trademark.

<<Dispersant>>

From the viewpoint of improving dispersibility of the pigment included in the colored layer, the colored layer may contain a dispersant. In a case where the colored layer contains a dispersant, dispersibility of the pigment in the formed colored layer is improved, and the color tone of the decorative film to be obtained can be uniformized.

The dispersant can be appropriately selected and used according to the type and shape of the pigment, but is preferably a polymer dispersant. Examples of the polymer dispersant include silicone polymers, acrylic polymers, and polyester polymers.

In a case where it is desired to impart heat resistance to the decorative film, silicone polymers such as a graft type silicone polymer are suitably used as the dispersant.

A weight-average molecular weight of the dispersant is preferably 1,000 to 5,000,000, more preferably 2,000 to 3,000,000, and particularly preferably 2,500 to 3,000,000. In a case where the weight-average molecular weight is 1,000 or more, dispersibility of the pigment is further improved.

As the dispersant, a commercially available product may be used. Examples of the commercially available product include EFKA 4300 (acrylic polymer dispersant) manufactured by BASF Japan, HOMOGENOL L-18, HOMOGENOL L-95, and HOMOGENOL L-100 manufactured by Kao Corporation, Solsperse 20000 and Solsperse 24000 manufactured by Lubrizol Corporation, and DISPERBYK-110, DISPERBYK-164, DISPERBYK-180, and DISPERBYK-182 manufactured by BYK Chemie Japan. “HOMOGENOL”, “Solsperse”, and “DISPERBYK” are all registered trademarks.

In a case where the colored layer contains the dispersant, the colored layer may contain only one kind of dispersant or two or more kinds of dispersants. The content of the dispersant is preferably 1 part by mass to 30 parts by mass with respect to 100 parts by mass of the colorant.

<<Polymerization Initiator>>

The colored layer may include a polymerization initiator. From the viewpoint of increasing sensitivity to exposure, the polymerization initiator is preferably a photopolymerization initiator. As the photopolymerization initiator, for example, polymerization initiators described in paragraphs 0031 to 0042 of JP2011-95716A and oxime-based polymerization initiators described in paragraphs 0064 to 0081 of JP2015-014783A can be used.

Specific examples of the photopolymerization initiator include 1-[4-(phenylthio)phenyl]-1,2-octanedione-2-(O-benzoyloxime) (for example, IRGACURE (registered trademark) OXE-01 manufactured by BASF), [9-ethyl-6-(2-methylbenzoyl)-9H-carbazol -3 -yl]ethan-1-one-1-(O-acetyloxime) (for example, IRGACURE (registered trademark) OXE-02 manufactured by BASF), 2-(dimethylamino)-2-[(4-methylphenyl)methyl]-1-[4-(4-morpholinyl)phenyl]-1-butanone (for example, IRGACURE (registered trademark) 379EG manufactured by BASF), 2-methyl -1-(4-methylthiophenyl)-2-morpholinopropan-1-one (for example, IRGACURE (registered trademark) 907 manufactured by BASF), 2-hydroxy-1-{4-[4-(2-hydroxy-2-methylpropionyl)benzyl]phenyl}-2-methyl-propan-1-one (for example, IRGACURE (registered trademark) 127 manufactured by BASF), 2-benzyl-2-dimethylamino-1-(4-morpholinophenyl)butanone-1 (for example, IRGACURE (registered trademark) 369 manufactured by BASF), 2-hydroxy-2-methyl-1-phenylpropan-1-one (for example, IRGACURE (registered trademark) 1173 manufactured by BASF), 1-hydroxycyclohexyl phenyl ketone (for example, IRGACURE (registered trademark) 184 manufactured by BASF), 2,2-dimethoxy-1,2-diphenylethan-1-one (for example, IRGACURE (registered trademark) 651 manufactured by BASF), product name: Lunar 6 which is an oxime ester-based polymerization initiator (manufactured by DKSH Japan), 2,4-diethylthioxanthone (for example, KAYACURE DETX-S manufactured by Nippon Kayaku Co., Ltd.), and DFI-091 and DFI-020 which are fluorene oxime-based polymerization initiator (both manufactured by DAITO CHEMIX Co., Ltd.).

Among these, from the viewpoint of increasing curing sensitivity, an initiator other than a halogen-containing polymerization initiator, such as a trichloromethyltriazine-based compound, is preferably used, and oxime-based polymerization initiators such as an α-aminoalkylphenone-based compound, an α-hydroxyalkylphenone-based compound, and an oxime ester-based compound are more preferable.

The content of the polymerization initiator is preferably 0.1 parts by mass to 15 parts by mass and more preferably 0.5 parts by mass to 10 parts by mass with respect to 100 parts by mass of the polymerizable compound.

<<Binder Resin>>

From the viewpoint of reducing curing shrinkage of the colored layer, the colored layer preferably contains a binder resin. The binder resin is not particularly limited, and a known resin can be appropriately selected. From the viewpoint of obtaining a target color tone, as the binder resin, a transparent resin is preferable, and specifically, a resin having a total light transmittance of 80% or more is preferable. The total light transmittance can be measured by a spectrophotometer (for example, spectrophotometer UV-2100 manufactured by Shimadzu Corporation).

Examples of the binder resin include acrylic resins, silicone resins, polyester resins, urethane resins, and olefin resins. Among these, from the viewpoint of transparency, acrylic resins, silicone resins, or polyester resins are preferable, and acrylic resins or silicone resins are more preferable. Furthermore, from the viewpoint of heat resistance, silicone resins are preferable.

The “acrylic resin” in the present disclosure means a resin including a constitutional unit derived from an acrylic monomer having a (meth)acryloyl group. The (meth)acryloyl group is a concept including a methacryloyl group and an acryloyl group. The acrylic resin includes, for example, an acrylic acid homopolymer, a methacrylic acid homopolymer, an acrylic acid ester homopolymer, a methacrylic acid ester homopolymer, a copolymer of acrylic acid and other monomers, a copolymer of methacrylic acid and other monomers, a copolymer of acrylic acid ester and other monomers, a copolymer of methacrylic acid ester and other monomers, and a urethane-modified copolymer having a urethane skeleton in the side chain. Examples of the acrylic resin include a glycidyl methacrylate adduct of a cyclohexyl methacrylate/methyl methacrylate/methacrylic acid copolymer, a random copolymer of benzyl methacrylate/methacrylic acid, a copolymer of allyl methacrylate/methacrylic acid, and a copolymer of benzyl methacrylate/methacrylic acid/hydroxyethyl methacrylate.

As the silicone resin, a known silicone resin can be used, and examples thereof include methyl-based straight silicone resins, methylphenyl-based straight silicone resins, acrylic resin-modified silicone resins, ester resin-modified silicone resins, epoxy resin-modified silicone resins, and alkyd resin-modified silicone resins, and rubber-based silicone resins. Among these, methyl-based straight silicone resins, methylphenyl-based straight silicone resins, acrylic resin-modified silicone resins, or rubber-based silicone resins are preferable, and methyl-based straight silicone resins, methylphenyl-based straight silicone resins, or rubber-based silicone resins are more preferable.

As the silicone resin, a commercially available product may be used, and examples of the commercially available product include KR-300, KR-311, KR-251, X-40-2406M, and KR-282 manufactured by Shin-Etsu Chemical Co., Ltd.

Examples of the polyester resin include a linear saturated polyester synthesized from aromatic dibasic acid or an ester-forming derivative thereof, and diol or an ester-forming derivative thereof. Specific examples of the linear saturated polyester include polyethylene terephthalate, polyethylene isophthalate, polybutylene terephthalate, poly(1,4-cyclohexylene dimethylene terephthalate), and polyethylene-2,6-naphthalate.

From the viewpoint of reducing curing shrinkage of the colored layer, the content of the binder resin is preferably 5% by mass to 70% by mass, more preferably 10% by mass to 60% by mass, and still more preferably 20% by mass to 60% by mass with respect to the total mass of the colored layer. In addition, the ratio of the total amount of the binder resin to the total amount of the polymerizable compound including the specific polymerizable compound, that is, the total amount of the polymerizable compound/the total amount of the binder resin is preferably 0.3 to 1.5 and more preferably 0.5 to 1.0.

<<Other Components>>

The colored layer may contain additives as necessary, in addition to the above-described components. As the additive, a known additive can be used, and examples thereof include surfactants described in paragraph 0017 of JP4502784B and paragraphs 0060 to 0071 of JP2009-237362A, thermal polymerization inhibitor described in paragraph 0018 of JP4502784B (also referred to as a polymerization inhibitor; preferably, phenothiazine), and other additives described in paragraphs 0058 to 0071 of JP2000-310706.

<<Formation of Colored Layer>>

The method for forming the colored layer is not particularly limited, but it is preferable that the colored layer is formed using a composition for forming the colored layer. The composition for forming the colored layer preferably contains the colorant, and more preferably contains the colorant and an organic solvent. In addition, the composition for forming the colored layer may further contain the above-described other components. The composition for forming the colored layer can be prepared, for example, by mixing an organic solvent, and components contained in the colored layer, such as the colorant. The content of the components contained in the colored layer is described as the content (% by mass) with respect to the total mass of the colored layer, but in a case where these components are contained in the composition for forming the colored layer, the content thereof may be considered as the content (% by mass) with respect to the total solid content of the composition for forming the colored layer.

In addition, in a case where the composition for forming the colored layer contains a pigment as the colorant, from the viewpoint of enhancing uniform dispersibility and dispersion stability of the pigment, it is preferable that a pigment dispersion liquid containing the pigment and a dispersant thereof is prepared in advance and the composition for forming the colored layer is prepared using the pigment dispersion liquid.

As the composition for forming the colored layer, a composition prepared in advance by the above-described method may be used, a commercially available product or the like may be used, or a composition for forming the colored layer may be prepared immediately before coating.

—Organic Solvent—

As the organic solvent, a generally used organic solvent can be used without particular limitation. Specific examples thereof include organic solvents such as esters, ethers, ketones, and aromatic hydrocarbons. In addition, as the organic solvent in the composition for forming the colored layer, methyl ethyl ketone, propylene glycol monomethyl ether, propylene glycol monomethyl ether acetate, cyclohexanone, cyclohexanol, methyl isobutyl ketone, ethyl lactate, methyl lactate, and the like, which are the same as Solvent described in paragraphs 0054 and 0055 of US2005/282073A, can also be suitably used. Among these, as the organic solvent in the composition for forming the colored layer, 1-methoxy-2-propyl acetate, methyl 3-ethoxypropionate, ethyl 3 -ethoxypropionate, ethyl cellosolve acetate, ethyl lactate, butyl acetate, methyl 3-methoxypropionate, 2-heptanone, cyclohexanone, diethylene glycol monoethyl ether acetate (ethyl carbitol acetate), diethylene glycol monobutyl ether acetate (butyl carbitol acetate), propylene glycol methyl ether acetate, methyl ethyl ketone, and the like are preferably used. These organic solvents may be used singly, or two or more kinds thereof may be used in combination. In addition, the content of the organic solvent is not particularly limited, but is preferably 5% by mass to 90% by mass and more preferably 30% by mass to 70% by mass with respect to the total mass of the composition for forming the colored layer (for example, a coating liquid).

<Adhesive Layer>

From the viewpoint of adhesiveness to the housing to which the decorative film is attached, or adhesiveness between layers, the decorative film according to the embodiment of the present disclosure preferably includes an adhesive layer. A material of the adhesive layer is not particularly limited and can be appropriately selected depending on the purpose. Examples of the adhesive layer include a layer including a known pressure sensitive adhesive or adhesive.

<<Pressure Sensitive Adhesive>>

Examples of the pressure sensitive adhesive include an acrylic pressure sensitive adhesive, a rubber-based pressure sensitive adhesive, and a silicone-based pressure sensitive adhesive. In addition, examples of the pressure sensitive adhesive include acrylic pressure sensitive adhesives, ultraviolet (UV) curable pressure sensitive adhesives, and silicone-based pressure sensitive adhesives described in Chapters 2 of “Characterization evaluation of release paper, release film, and adhesive tape, and control technique thereof”, 2004, Information Mechanism. In a case where the adhesive layer contains a pressure sensitive adhesive, the adhesive layer may further contain a viscosity imparting agent.

<<Adhesive>>

Examples of the adhesive include a urethane resin adhesive, a polyester adhesive, an acrylic resin adhesive, an ethylene vinyl acetate resin adhesive, a polyvinyl alcohol adhesive, a polyamide adhesive, and a silicone adhesive. From the viewpoint of higher adhesive force, a urethane resin adhesive or a silicone adhesive is preferable.

In the decorative film according to a certain embodiment, it is preferable that a relationship between a thickness (T2) of the colored layer, the reflective layer (T3) (preferably, a thickness of the cholesteric liquid crystal layer), and a thickness (T4) of the adhesive layer satisfies T4<10(T2+T3). By satisfying the above-described relationship, it is possible to obtain a decorative film which is a thin film and has excellent lustrousness and visibility. T4<8(T2+T3) is more preferable, T4<5(T2+T3) is still more preferable, and T4<3(T2+T3) is particularly preferable.

<<Method for Forming Adhesive Layer>>

A method for forming the adhesive layer is not particularly limited, and examples thereof include a method of laminating a protective film on which the adhesive layer has been formed so that the adhesive layer and an object (for example, the reflective layer, the alignment layer, or the colored layer) are in contact with each other, a method of laminating the adhesive layer alone so as to be in contact with an object (for example, the reflective layer, the alignment layer, or the colored layer), and a method of applying a composition including the pressure sensitive adhesive or the adhesive to an object (for example, the reflective layer, the alignment layer, or the colored layer). As a laminating method, a known method can be used. Preferred examples of an applying method include the same method as the applying method of the liquid crystal composition.

From the viewpoint of both pressure sensitive strength and handleability, a thickness of the adhesive layer in the decorative film is preferably 2 μm to 40 μm, more preferably 3 μm to 25 μm, still more preferably 4 μm to 20 μm, and particularly preferably 4 μm to 15 μm.

<Other Layers>

The decorative film according to the embodiment of the present disclosure may have other layers in addition to the above-described layers. Examples of the other layers include a self-repairing layer, an antistatic layer, an antifouling layer, an anti-electromagnetic wave layer, and a conductive layer, which are known as a layer for a decorative film. The other layers in the decorative film according to the embodiment of the present disclosure can be formed by known methods. Examples thereof include a method of applying a composition (composition for forming a layer) containing components included in these layers in a layered shape, and drying the composition.

<<Cover Film>>

For the purpose of preventing stains, and the like, the decorative film according to the embodiment of the present disclosure may include a cover film as an outermost layer on the reflective layer side based on the base material. The cover film is not particularly limited as long as the cover film is formed of a material having flexibility and good peelability, and examples thereof include resin films. Examples of the resin film include a polyethylene film. The cover film is introduced into the decorative film, for example, by attaching the cover film to an object (for example, the reflective layer). The method for attaching the cover film is not particularly limited, and examples thereof include a known attaching method, such as a method of laminating the cover film on the object (for example, the reflective layer).

<Layer Configuration of Decorative Film>

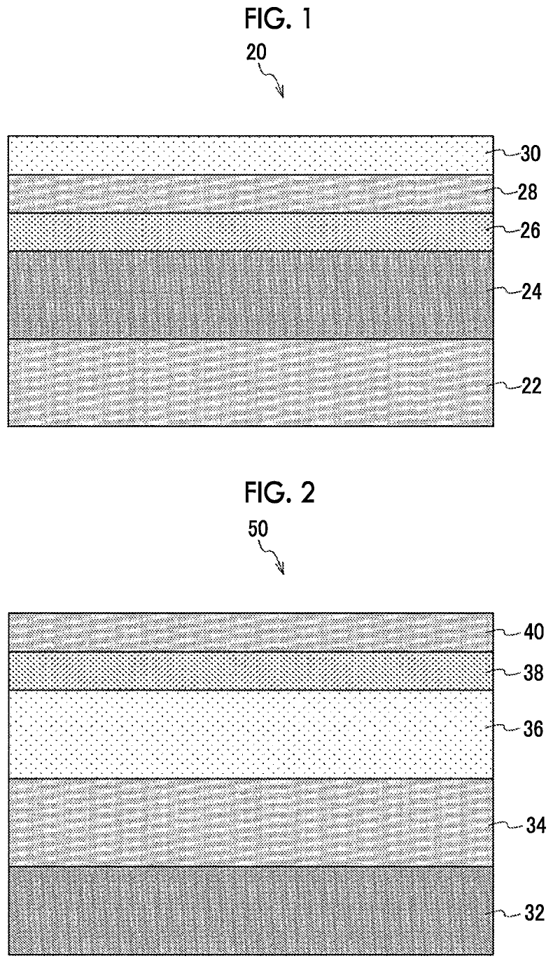

Here, examples of a layer configuration of the decorative film will be described with reference to FIGS. 1 and 2, respectively. However, the layer configuration of the decorative film is not limited to the layer configuration shown in each figure. FIG. 1 is a schematic cross-sectional view showing an example of layer configuration of the decorative film according to the embodiment of the present disclosure. A decorative film 20 shown in FIG. 1 includes a base material 22, a colored layer 24 on the base material 22, an alignment layer 26 on the colored layer 24, a cholesteric liquid crystal layer (reflective layer) 28 on the alignment layer 26, and a pressure-sensitive adhesive layer 30 on the cholesteric liquid crystal layer 28.

FIG. 2 is a schematic cross-sectional view showing an example of layer configuration of the decorative film according to the embodiment of the present disclosure. A decorative film 50 shown in FIG. 2 includes a colored layer 32, a base material 34 on the colored layer 32, a resin layer 36 on the base material 34, an alignment layer 38 on the resin layer 36, and a cholesteric liquid crystal layer (reflective layer) 40 on the alignment layer 38.

<Method for Manufacturing Decorative Film>

A method for manufacturing the decorative film according to the embodiment of the present disclosure is not limited. For example, by providing the reflective layer and a layer other than the reflective layer as necessary on the base material, a decorative film having at least the base material and the reflective layer can be manufactured. As a method for forming each layer, the above-described method can be used. A plurality of laminates including two or more layers may be manufactured in advance, and the plurality of laminates may be laminated to be manufactured.

(Decoration Method and Decoration Product)

A decoration method according to the present disclosure is not particularly limited as long as a decoration method using the decorative film according to the embodiment of the present disclosure. It is preferable that the decoration method according to the present disclosure includes, for example, a step of attaching a surface of the decorative film on the reflective layer side and a convex surface of a transparent body having a convex structure by a laminating or molding processing process. The decoration product according to the present disclosure is a decoration product using the decorative film according to the embodiment of the present disclosure, and is preferably a decoration product obtained by the decoration method according to the embodiment of the present disclosure.

In a step of attaching the surface of the decorative film on the reflective layer side and the convex surface of the transparent body having the convex structure, it is preferable to pre-activate the surface of the decorative film having the reflective layer and/or the convex surface of the transparent body having the convex structure. Adhesiveness is improved by the pre-activation treatment. Examples of the activation treatment include a corona treatment, a plasma treatment, and a silane coupling material treatment. The corona treatment is most preferable from the viewpoint of simplicity of the production process.

(Decorative Molded Article)

The decorative molded article according to the embodiment of the present disclosure includes a base material and a reflective layer having a convex structure having a specific shape. The decorative molded article is a form of a decoration product. According to the above-described embodiment, a decorative molded article having high lustrousness and rich tint change depending on a viewing direction.

<Base Material>

The decorative molded article according to the embodiment of the present disclosure includes a base material. As the base material, for example, the base material described in the section of “Decorative film” above can be used. Preferred aspects of the base material are the same as the preferred aspects of the base material described in the section of “Decorative film” above. The base material may have a linear convex structure.

<Reflective Layer>

The decorative molded article according to the embodiment of the present disclosure includes a reflective layer. The reflective layer has a convex structure. As the reflective layer, the reflective layer described in the section of “Decorative film” above can be used. Preferred aspects of the reflective layer are the same as the preferred aspects of the reflective layer described in the section of “Decorative film” above. In a certain embodiment, the reflective layer is preferably a layer which includes a cholesteric liquid crystal.

<Resin Layer>

The decorative molded article according to the embodiment of the present disclosure preferably includes a resin layer between the base material and the reflective layer. The resin layer particularly contributes to the formation of the convex structure in the reflective layer. For example, with the resin layer, it is possible to improve followability of the reflective layer to the surface having the convex structure (that is, the convex surface) used as a mold for imparting the convex structure to the reflective layer. As a result, a desired convex structure can be easily imparted to the reflective layer.

As the resin layer, the resin layer described in the section of “Decorative film” above can be used. Preferred aspects of the resin layer are the same as the preferred aspects of the resin layer described in the section of “Decorative film” above. The resin layer may have a convex structure. The resin layer preferably has the same convex structure as that of the reflective layer.

A thickness of the resin layer is preferably 0.5 times to 10 times, more preferably 0.8 times to 8 times, and particularly preferably 1 time to 5 times with respect to a depth (height) of the convex structure of the reflective layer.

<Colored Layer>

The decorative molded article according to the embodiment of the present disclosure preferably includes a colored layer. As the colored layer, the colored layer described in the section of “Decorative film” above can be used. Preferred aspects of the colored layer are the same as the preferred aspects of the colored layer described in the section of “Decorative film” above. The colored layer may have a convex structure.

A position of the colored layer is not limited. In a certain embodiment, the colored layer is preferably disposed between the base material and the reflective layer. That is, it is preferable that the decorative molded article according to a certain embodiment includes the base material, the colored layer, and the reflective layer in this order. In a certain embodiment, it is preferable that the colored layer is disposed on a side of the base material opposite to the reflective layer. That is, it is preferable that the decorative molded article according to a certain embodiment includes the colored layer, the base material, and the reflective layer in this order.

<Alignment Layer>

The decorative molded article according to the embodiment of the present disclosure may include an alignment layer. The alignment layer is preferably in contact with the reflective layer (preferably, the cholesteric liquid crystal layer). As the alignment layer, the alignment layer described in the section of “Decorative film” above can be used. Preferred aspects of the alignment layer are the same as the preferred aspects of the alignment layer described in the section of “Decorative film” above. The alignment layer may have a convex structure.

<Adhesive Layer>

The decorative molded article according to the embodiment of the present disclosure may include an adhesive layer. The adhesive layer may be disposed on the surface of the decorative molded article. The adhesive layer may be disposed between any two layers included in the decorative molded article. As the adhesive layer, the adhesive layer described in the section of “Decorative film” above can be used. Preferred aspects of the adhesive layer are the same as the preferred aspects of the adhesive layer described in the section of “Decorative film” above. The adhesive layer may have a convex structure.

<Transparent Body having Convex Structure>

The decorative molded article according to the embodiment of the present disclosure preferably includes a transparent body having a convex structure. Among these, it is preferable to have a sheet in which a convex shape is formed by a resin base material and a cured product of a curable composition, provided on at least one surface of the resin base material.

(Resin Base Material)

Examples of the resin base material include a sheet or film of an acrylic resin, a polyester resin, a polycarbonate resin, and the like.

Examples of the acrylic resin include polymethyl methacrylate.

Examples of the polyester resin include polyethylene terephthalate (PET) and polyethylene naphthalate (PEN).

A thickness of the resin base material is not particularly limited, and is preferably in a range of 50 μm or more and 300 μm or less and more preferably in a range of 50 μm or more and 200 μm or less in a case of uniformly molding (forming) at a high temperature. Within the above-described range, the resin base material is less likely to be torn, cracks are less likely to occur during handling (for example, during transportation) in the molding process, and cracks are less likely to occur during three-dimensional molding.

As the resin base material, a commercially available product on the market may be used. For example, an acrylic resin film (ACRYPLEN HBS010P (PMMA film), thickness: 125 μm) manufactured by Mitsubishi Chemical Corporation, a polyethylene terephthalate resin film (LUMIRROR S10, thickness: 100 μm) manufactured by Toray Industries, Inc., and a polycarbonate resin film (IUPILON H-3000, thickness: 125 μm) manufactured by Teijin Chemicals Ltd.

In the transparent body having a convex structure, it is preferable to include a step (composition preparation step) of preparing a curable resin composition, a step (sheet production step) of curing a photo- or thermocurable composition by irradiation with an active energy ray or by heating to produce a molding sheet, and a step of molding the curable composition into a desired shape using a mold such as a metal mold and a wooden mold.

Specifically, for example, a mold processed into a desired convex shape may be prepared, a curable composition may be poured into the mold, the curable composition may be dried as necessary to cure the curable composition. As a result, a molded product molded into a desired shape is stably obtained.

Next, a radical is generated by irradiation the curable composition with an active energy ray, and the curable composition cures as the polymerization reaction of the polymerizable compound proceeds. As a result, a convex shape which is a cured product of the curable composition is formed.

In molding the convex shape, the curable composition may be cured after the resin base material is brought into contact with the curable composition in advance before the curable composition is cured. By curing the resin base material in contact with the curable composition, it is expected that adhesiveness due to curing shrinkage is further improved, and in addition to the adhesion effect derived from the composition, adhesiveness to the resin base material can be improved more effectively.

The mold for forming the convex structure can be produced by a known method such as cutting and etching. It is preferable to use a mold produced by an etching process because it is easy to obtain lustrousness in a case where the decoration product is held in a hand and viewed obliquely. From the viewpoint of lustrousness in a case of being viewed from the front, it is preferable to use a mold produced by cutting.

<Other Layers>

The decorative molded article according to the embodiment of the present disclosure may include layers other than the above-described layers. As other layers, for example, the other layers described in the section of “Decorative film” above can be used.

The decorative molded article according to the embodiment of the present disclosure may include a transparent body having a surface having a convex structure (that is, a convex surface). In a certain embodiment, it is preferable that the decorative molded article includes the base material, a reflective layer, and a transparent body having a surface having an uneven structure in this order. For example, by observing the decorative molded article in a direction from the transparent body toward the base material, the user can observe the decorative molded article having high lustrousness and a uniform tint regardless of the viewing direction. The transparent body is preferably in contact with the reflective layer (preferably, the cholesteric liquid crystal layer). The transparent body may be in contact with the reflective layer through another layer (for example, the alignment layer). It is preferable that the convex surface of the transparent body faces the reflective layer. Examples of the transparent body include a transparent resin and glass.

<Layer Configuration of Decorative Molded Article>

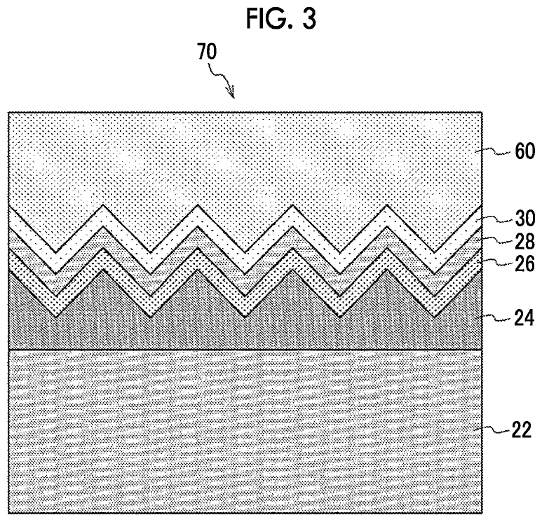

Examples of layer configurations of the decorative molded article will be described with reference to FIGS. 3, 4, and 5, respectively. However, the layer configuration of the decorative molded article is not limited to the layer configuration shown in each figure.

FIG. 3 is a schematic cross-sectional view showing an example of the decorative molded article according to the embodiment of the present disclosure. A decorative molded article 70 shown in FIG. 3 includes a base material 22, a colored layer 24, an alignment layer 26, a cholesteric liquid crystal layer (reflective layer) 28, an adhesive layer 30, and a transparent body 60 having a linear convex structure in this order. The transparent body 60 is a form of the transparent body.

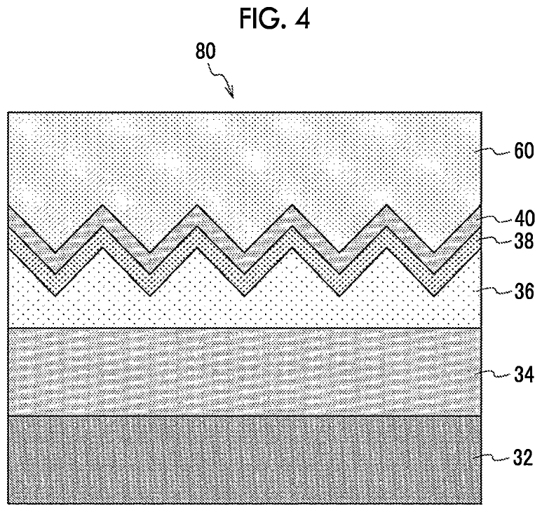

FIG. 4 is a schematic cross-sectional view showing an example of the decorative molded article according to the embodiment of the present disclosure. A decorative molded article 80 shown in FIG. 4 includes a colored layer 32, a base material 34, a resin layer 36, an alignment layer 38, a cholesteric liquid crystal layer (reflective layer) 40, and a transparent body 60 having a linear convex structure in this order.

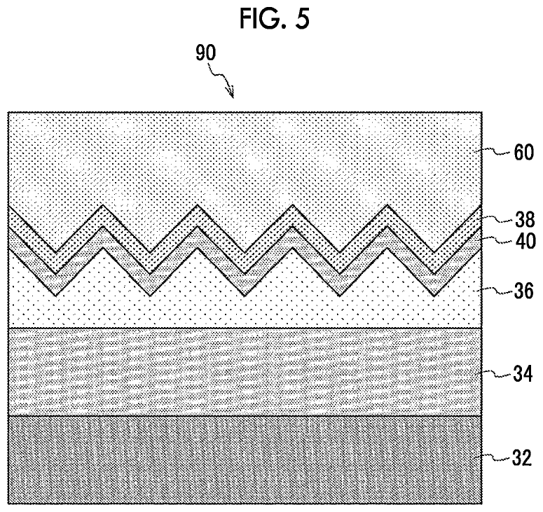

FIG. 5 is a schematic cross-sectional view showing an example of the decorative molded article according to the embodiment of the present disclosure. A decorative molded article 90 shown in FIG. 5 includes a colored layer 32, a base material 34, a resin layer 36, a cholesteric liquid crystal layer (reflective layer) 40, an alignment layer 38, and a transparent body 60 having a linear convex structure in this order.

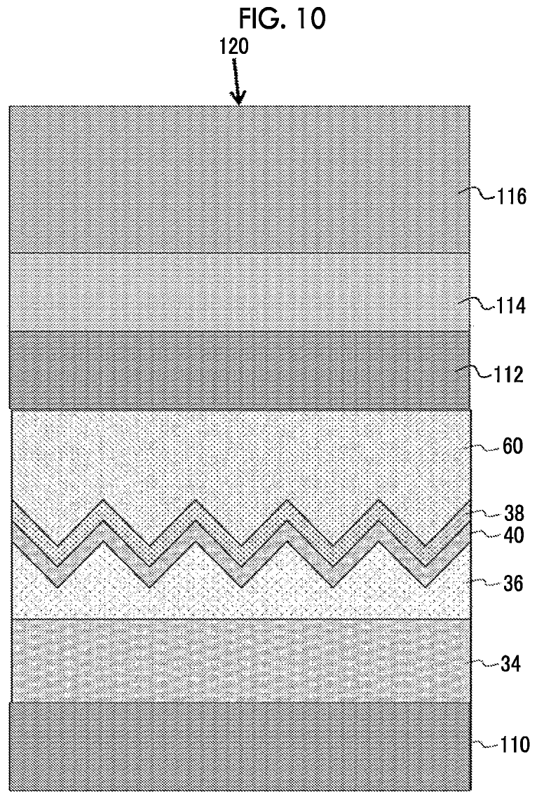

FIG. 10 is a schematic cross-sectional view showing an example of a decorative molded article for a display according to the embodiment of the present disclosure. A decorative molded article 120 shown in FIG. 10 includes a retardation layer 110 of a ¼ wavelength plate, a base material 34, a resin layer 36, a cholesteric liquid crystal layer (reflective layer) 40, an alignment layer 38, a transparent body 60 having a linear convex structure, a retardation layer 112 of ¼ wavelength plate, a pressure-sensitive adhesive layer 114, and a liquid crystal axisymmetric polarization converter 116 in this order.

<Method for Manufacturing Decorative Molded Article>

A method for manufacturing the decorative molded article according to the embodiment of the present disclosure is preferably a method using the decorative film according to the embodiment of the present disclosure. In the method for manufacturing the decorative molded article according to the embodiment of the present disclosure, a step of attaching the decorative film to the transparent body having a convex structure on the reflective layer side is preferable. Since the decorative film according to the embodiment of the present disclosure has excellent three-dimensional moldability, the decorative film according to the embodiment of the present disclosure can be suitably used for manufacturing a decorative molded article, and for example, it is particularly suitable for manufacturing a decorative molded article by at least one molding selected from the group consisting of thermal lamination, three-dimensional molding, and insert molding. In addition, according to the decorative film according to the embodiment of the present disclosure, it is also possible to obtain a decorative molded article by attaching the decorative film according to the embodiment of the present disclosure to a molded article after molding. In a case of using the decorative film according to the embodiment of the present disclosure in a case of producing a decorative molded article, it can be applied to molds having more a complicated shape, smaller shape, and the like, which expands the range of applications of the decorative molded article. The layer configuration of the decorative molded article obtained by using the decorative film reflects the layer configuration of the decorative film. In other words, the decorative molded article obtained by using the decorative film includes each layer included in the decorative film.

In addition, suitable examples of the molding include three-dimensional molding. Suitable examples of the three-dimensional molding include heat molding, vacuum molding, pressure molding, and vacuum pressure molding. A method of performing the vacuum molding is not particularly limited, but is preferably a method of performing three-dimensional molding in a heated state under vacuum. The vacuum means a state in which an inside of a chamber is reduced to a degree of vacuum of 100 Pa or less. It is sufficient that the temperature in a case of performing the three-dimensional molding is appropriately set depending on the used base material for molding, but the temperature is preferably in a temperature range of 60° C. or higher, more preferably in a temperature range of 80° C. or higher, and still more preferably in a temperature range of 100° C. or higher. The upper limit of the temperature in a case of performing the three-dimensional molding is preferably 200° C. The temperature in a case of performing the three-dimensional molding means a temperature of the base material for molding supplied for the three-dimensional molding, and is measured by attaching a thermocouple to the surface of the base material for molding.

The vacuum molding can be performed using a vacuum molding technique widely known in the molding field, and for example, the vacuum molding may be performed using Formech 508FS manufactured by NIHON SEIZUKI KOGYO CO., LTD.

Hereinafter, the method for manufacturing the decorative molded article will be specifically described. It is preferable that the method for manufacturing the decorative molded article according to the embodiment of the present disclosure includes a step of preparing a decorative film having at least a base material and a reflective layer, and a step of bringing the reflective layer into contact with a surface having a convex structure and applying a pressure of 0.01 MPa or more to the reflective layer to impart a convex structure to the reflective layer. The surface having a convex structure functions as a mold for imparting the convex structure to the reflective layer. By bringing the reflective layer into contact with the surface having an uneven structure and pressurizing the reflective layer, the reflective layer is deformed along the surface having the convex structure. As a result, the convex structure is imparted to the reflective layer.

The layer configuration of the decorative film may be determined according to the layer configuration of the desired decorative molded article. For example, by using a decorative film having a base material, a reflective layer, and a resin layer between the base material and the reflective layer, a decorative molded article including the base material, the resin layer, and the reflective layer in this order is obtained.

The surface having a convex structure is defined by an outer surface of various articles. The surface having a convex structure may be, for example, a surface of a mold or a surface of an article other than the mold.

In the process of bringing the reflective layer into contact with the surface having a convex structure, the reflective layer may be brought close to the surface having a convex structure, or the surface having a convex structure may be brought close to the reflective layer. The reflective layer may be brought into contact with the surface having a convex structure through another layer (for example, an alignment layer).

The pressure applied to the reflective layer is preferably 0.1 MPa or more, more preferably 0.3 MPa or more, and particularly preferably 0.5 MPa or more. The upper limit of the pressure applied to the reflective layer is not limited. The upper limit of the pressure applied to the reflective layer may be determined, for example, in accordance with workability of the reflective layer and the thickness of the decorative film. The pressure applied to the reflective layer is preferably 10 MPa or less, more preferably 3 MPa or less, and particularly preferably 1 MPa or less.

A method of applying the pressure to the reflective layer is not limited, and a known method can be used. Examples of the method of applying the pressure include a method using compressed air and a method using a pressing machine.

In the method for manufacturing the decorative molded article, as the article having the surface having a convex structure, for example, a transparent body having the surface having a convex structure (that is, a convex surface) may be used. For example, in a method for manufacturing the decorative molded article according to a certain embodiment, it is preferable to include a step of preparing a decorative film having at least a base material and a reflective layer which has a central wavelength of a selective reflection wavelength in a range of 300 nm or more and 1,500 nm or less; and a step of bringing the reflective layer into contact with the surface having a convex structure by superimposing the transparent body having the surface having a convex structure and the decorative film, and then applying a pressure of 0.01 Mpa or more to the reflective layer to impart a convex structure to the reflective layer. After imparting the convex structure to the reflective layer, the transparent body may or may not be removed. In a case where the transparent body is not removed, the transparent body is disposed, for example, as an outer layer of the decorative molded article.

<Use>

The use of the decorative molded article obtained as described above is not particularly limited, and the decorative molded article can be used for various articles. Particularly suitable examples of the use of the decorative molded article include interiors and exteriors of electronic devices (for example, wearable devices and smartphones), interiors and exteriors of automobiles, interiors and exteriors of electric appliances, and packaging containers.

(Decorative Panel)

A decorative panel according to the embodiment of the present disclosure includes the decorative film according to the embodiment of the present disclosure or a molded product thereof, and preferably includes the decorative film according to the embodiment of the present disclosure.

In addition, it is preferable that the decorative panel according to the embodiment of the present disclosure includes the decorative molded article according to the embodiment of the present disclosure. The decorative molded article in the decorative panel has the same meaning as the decorative molded article described in the section of “Decorative molded article” above.

The decorative panel can be manufactured, for example, by adhering a surface of the decorative molded article on the reflective layer side to a surface of a member serving as a surface layer portion of the decorative panel. Examples of the member serving as the surface layer portion of the decorative panel include a glass panel. For example, the above-described adhesive layer can be used for adhering the decorative molded article to the member serving as the surface layer portion of the decorative panel. The decorative molded article may be used alone as the decorative panel without combining the decorative molded article with other members.

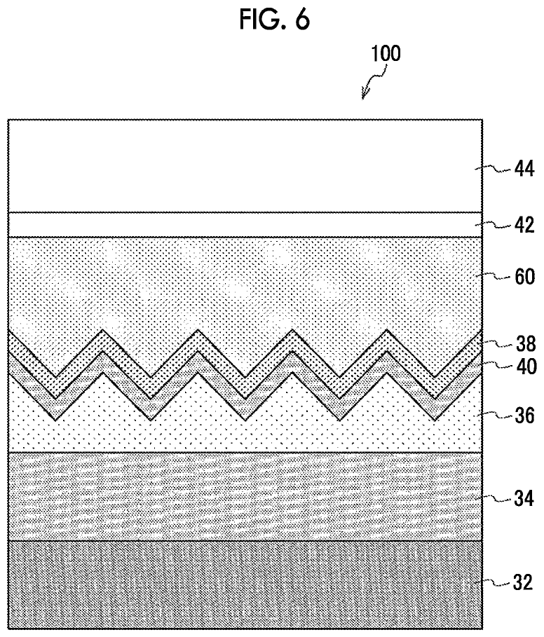

An example of a layer configuration of the decorative panel will be described with reference to FIG. 6. However, the layer configuration of the decorative panel is not limited to the layer configuration shown in FIG. 6. FIG. 6 is a schematic cross-sectional view showing an example of a decorative panel according to an embodiment of the present disclosure. A decorative panel 100 shown in FIG. 6 includes a colored layer 32, a base material 34, a resin layer 36, a cholesteric liquid crystal layer (reflective layer) 40, an alignment layer 38, a transparent body 60 having a convex structure, an adhesive layer 42, and a glass panel 44 in this order.

A shape of the decorative panel is not limited. The shape of the decorative panel may be determined, for example, according to the use. The decorative panel may have, for example, a flat plate. In addition, the decorative panel may have a curved surface.

The decorative panel can be used, for example, for interiors and exteriors of various articles (for example, electronic devices, automobiles, and electric appliances). For example, in a case where the decorative panel 100 shown in FIG. 6 is used as a housing for an electronic device, it is preferable that the colored layer 32, the base material 34, the resin layer 36, the cholesteric liquid crystal layer (reflective layer) 40, the alignment layer 38, the transparent body 60 having a convex structure, the adhesive layer 42, and the glass panel 44 are arranged from the inside to the outside of the housing. By observing the decorative panel 100 in a direction from the glass panel 44 toward the colored layer 32, the user can observe the decorative panel having high lustrousness and a uniform tint regardless of the viewing direction.

(Electronic Device)

An electronic device according to the embodiment of the present disclosure includes the decorative panel according to the embodiment of the present disclosure. Examples of the electronic device include a wearable device and a smartphone. The decorative panel in the electronic device has the same meaning as the decorative panel described in the section of “Decorative panel” above. The decorative panel is preferably used as a housing for an electronic device.

A method for manufacturing the electronic device is not limited, and a known method can be used. In a case where the decorative panel is used as a housing for an electronic device, an electronic device including the decorative panel can be manufactured by housing various electronic components of the electronic device inside the housing including the decorative panel.

### EXAMPLES

Hereinafter, the present disclosure will be more specifically described with reference to Examples. The scope of the present disclosure is not limited to the specific examples shown below.

### Example 1 <Preparation of Support>

As a support, two sheets of COSMOSHINE (registered trademark) A4100 (PET, thickness: 50 μm, film having an easy adhesion layer on one side, manufactured by Toyobo Co., Ltd., A4 size) were prepared. Hereinafter, the two supports will be referred to as a support 1A and a support 1B, respectively.

[Composition of Coating Liquid 1 for Forming Alignment Layer]

Modified polyvinyl alcohol shown below: 28 parts by mass

Citric acid ester (AS3, manufactured by SANKYO KAGAKU YAKUHIN Co., Ltd.): 1.2 parts by mass

Photopolymerization initiator (IRGACURE 2959, manufactured by BASF): 0.84 parts by mass

Glutaraldehyde: 2.8 parts by mass

Water: 699 parts by mass

Methanol: 226 parts by mass

Modified polyvinyl alcohol (the following compounds; the numbers at the lower right of each constitutional unit represent the molar ratio)

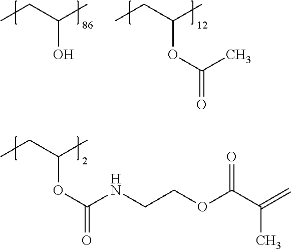

<Production of Laminate 1-1>

The coating liquid 1 for forming an alignment layer was applied onto a surface of the above-described support 1A, on which the easy adhesion layer was not formed, with a wire bar coater. Thereafter, the applied coating liquid 1 for forming an alignment layer was dried at 100° C. for 120 seconds to produce an alignment layer 1 having a layer thickness of 0.5 μm.

With regard to the above-described alignment layer 1 produced, the alignment layer 1 was subjected to a rubbing treatment (rayon cloth, pressure: 0.1 kgf (0.98 N), rotation speed: 1,000 rpm (revolutions per minute), transportation speed: 10 m/min, number of times: 1 round trip) in a direction rotated counterclockwise by 31.5° with respect to a short side direction.

<Formation of Cholesteric Liquid Crystal Layer 1>

With regard to the above-described alignment layer 1 produced, the alignment layer 1 was subjected to a rubbing treatment (rayon cloth, pressure: 0.1 kgf (0.98 N), rotation speed: 1,000 rpm (revolutions per minute), transportation speed: 10 m/minute, number of times: 1 round trip) in a direction rotated counterclockwise by 31.5° with respect to a short side direction. Components included in the coating liquid 1 for forming a cholesteric liquid crystal layer, which are shown below, were stirred and dissolved in a container kept at a temperature of 25° C. to prepare a coating liquid 1 for forming a cholesteric liquid crystal layer (liquid crystal composition 1).

[Composition of Coating Liquid 1 for Forming Cholesteric Liquid Crystal Layer]

Methyl ethyl ketone: 150.6 parts by mass

Liquid crystal compound 1 (rod-like liquid crystal compound): 92 parts by mass

Photopolymerization initiator A (IRGACURE 907, manufactured by BASF): 0.50 parts by mass

Chiral agent A: 4.00 parts by mass

Chiral agent B: 4.00 parts by mass

Surfactant F1 described below: 0.027 parts by mass

Liquid crystal compound 1 (monofunctional): rod-like liquid crystal compound shown below; in a case of a radical polymerization type, the liquid crystal compound 1 is defined as monofunctional because, although the liquid crystal compound 1 has an oxetanyl group (a cationically polymerizable functional group), the liquid crystal compound 1 has only one acryloxy group (radically polymerizable group); the same applies to the cationic polymerization type.

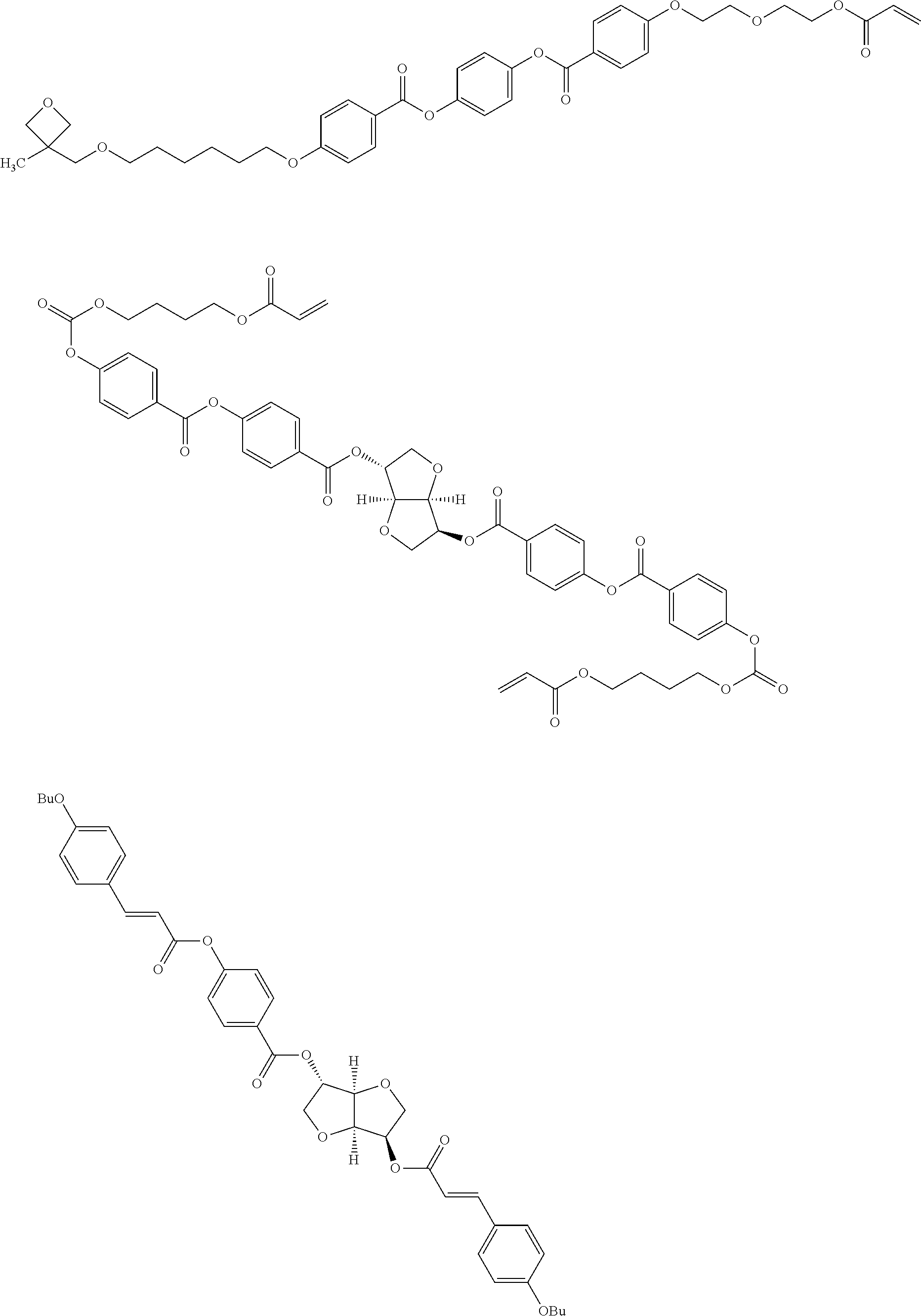

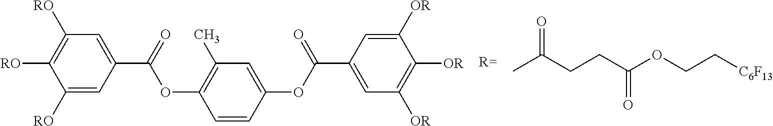

The coating liquid 1 for forming a cholesteric liquid crystal layer prepared above was applied onto the rubbing-treated surface of the alignment layer 1 with a wire bar coater, and dried at 85° C. for 120 seconds. The surface of the cholesteric liquid crystal layer of the formed laminate was entirely exposed with an exposure amount of 70 mJ/cm² (i rays) to form a cholesteric liquid crystal layer 1 having a layer thickness of 3.0 μm, thereby forming a laminate 1-1. The laminate 1-1 includes the support 1A, the alignment layer 1, and the cholesteric liquid crystal layer 1 in this order.

<Production of Laminate 1-2>

An acrylic pressure sensitive adhesive (SK-Dyne SG-50Y, manufactured by Soken Chemical & Engineering Co., Ltd.) was applied onto a surface of COSMOSHINE (registered trademark) A4100 (that is, the support 1B) prepared separately, on which the easy adhesion layer had been formed, with a comma coater, and dried at 120° C. for 2 minutes to form a resin layer 1 (adhesive layer) having a layer thickness of 20 μm, thereby forming a laminate 1-2. The laminate 1-2 includes the support 1B and the resin layer 1.

<Production of Laminate 1-3>

The laminate 1-1 and the laminate 1-2 were bonded together by a laminator such that the above-described resin layer 1 and the above-described cholesteric liquid crystal layer 1 were in contact with each other. By peeling off the PET film (that is, the support 1A) on the side of the laminate 1-1, a laminate 1-3 in which support 1B/resin layer 1/cholesteric liquid crystal layer 1/alignment layer 1 were laminated in this order was obtained.

<Preparation of Black Pigment Dispersion Liquid>

Carbon black, a dispersant, a polymer, and a solvent were mixed so as to be a black pigment dispersion liquid having a composition of the below, and a black pigment dispersion liquid was obtained by using a three-roll mill and a beads mill. An average particle diameter of the carbon black, measured using Microtrac FRA (Honeywell Japan Ltd.), was 163 nm.

—Composition of Clack Pigment Dispersion Liquid—

Resin-coated carbon black produced according to the description of paragraphs 0036 to 0042 of JP5320652B: 20.0% by mass

Dispersant 1 (the following structure): 1.0% by mass

Polymer (random copolymer of benzyl methacrylate/methacrylic acid=72/28 (molar ratio); weight-average molecular weight: 30,000): 6.0% by mass

Propylene glycol monomethyl ether acetate: 73.0% by mass

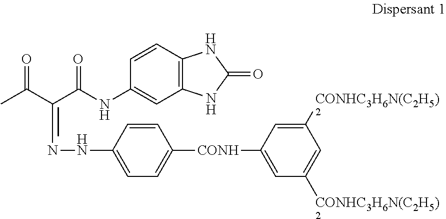

<Composition of Coating Liquid 1 for Forming Colored Layer>

Black pigment dispersion liquid: 30 parts by mass

Polymerizable compound 1: urethane acrylate oligomer, manufactured by Sartomer Japan Inc., CN-996NS: 25 parts by mass

Binder resin 3: ethyl acetate/ethyl methyl ketone/isopropyl alcohol solution containing 35% by mass of a urethane-modified acrylic polymer (containing polyol): 25 parts by mass

Photopolymerization initiator (IRGACURE 2959, manufactured by BASF): 1.0 part by mass

Methyl ethyl ketone: 19 parts by mass

<Production of Laminate 1>

The coating liquid 1 for forming a colored layer was applied onto the support 1B of the laminate 1-3 described above using a wire bar coater, and dried at 100° C. for 10 minutes. The surface of the colored layer of the formed laminate was entirely exposed with an exposure amount of 500 mJ/cm² (i rays) to form a colored layer 1 (black colored layer) having a layer thickness of 4 μm, thereby forming a laminate 1. The laminate 1 includes the colored layer 1, the support 1B, the resin layer 1, the cholesteric liquid crystal layer (reflective layer) 1, and the alignment layer 1 in this order.

<Molding>

The surface of the alignment layer 1 of the laminate 1 was subjected to a corona treatment using a table corona treatment device (TEC-8XA, manufactured by KASUGA DENKI, INC., setting output: 70 W, operation speed: lm/min, number of times: 5 reciprocations), and using a transparent body having a convex pattern (thickness: 2 mm, width: 50 mm, length: 50 mm) as a mold, the surface of the alignment layer 1 of the laminate 1 was brought into contact with the convex surface of the transparent body, and subjected to a compressed air molding (TOM molding) to obtain a molded article 1 (that is, a decorative molded article). The convex pattern had the shape shown in Example 1 in Table 1. A TOM molding machine NGF-0510-R (manufactured by Fu-se Vacuum Forming) was used for the compressed air molding, and the molding temperature was set to 120° C. and the stretching ratio was set to 30% at the highest portion. The pressure in the compressed air molding was 0.3 MPa.

<Measurement of Average Φ_{AVE} of Positive Tilt Angles>

A microtome (for example, RX-860 manufactured by YAMATO KOHKI INDUSTRIAL CO., LTD.) was used to cut the decorative film on an arbitrary plane in a direction (360° existing as a direction) perpendicular to the plane direction of the decorative film. The cutting direction could be predicted to some extent by observing the surface of the decorative film with a microscope (BX53M manufactured by Olympus Corporation). A cross-sectional shape was measured by observing the cut cross section with a scanning electron microscope (SU3800 manufactured by Hitachi High-Tech Corporation), and Φ_{AVE} was calculated.

<Performance Evaluation>

—hange in Tint for Each Viewing Direction (Evaluation of Change in Brightness in Case of Being Horizontally Rotated on Table)—

Using an ultraviolet-visible-near infrared spectrophotometer (manufactured by JASCO Corporation, V-750) and an automatic absolute reflectance measurement unit (manufactured by JASCO Corporation, ARMV-919), reflectance in a wavelength range of 380 nm to 780 nm was measured. The reflectance indicates the maximum value of reflection spectrum in a case where a horizontal axis represents the wavelength and a vertical axis represents the reflectance. Reflectance in a case where the molded article was set on a sample holder so that the first direction was an incident surface was defined as a highlight reflectance (R_{H}), and reflectance in a case where the same region was set so that the second direction was an incident surface was defined as a shade reflectance (R_{S}). A ratio (R_{H}/R_{S}) of the above-described reflectance was measured. However, the incidence angle and the light-receiving angle were set to be angles at which the ratio (R_{H}/R_{S}) of the above-described reflectance was maximized within a range of the incidence angle of 0° to −45° and the light-receiving angle of −90° to 90°. The angle indicates an absolute angle with the perpendicular line to the base material plane as 0°. Change in tint for each viewing direction was evaluated according to the following standard. As an evaluation result, C is preferable, B is more preferable, and A is particularly preferable.

<<Evaluation Standard>>

A: ratio (R_{H}/R_{S}) of the highlight reflectance (R_{H}) to the shade reflectance (R_{S}) was 100 or more.

B: ratio (R_{H}/R_{S}) of the highlight reflectance (R_{H}) to the shade reflectance (R_{S}) was 10 or more and less than 100.

C: ratio (R_{H}/R_{S}) of the highlight reflectance (R_{H}) to the shade reflectance (R_{S}) was 1.2 or more and less than 10.

D: ratio (R_{H}/R_{S}) of the highlight reflectance (R_{H}) to the shade reflectance (R_{S}) was less than 1.2.

—Evaluation of In-Plane Brightness and Darkness Contrast (Evaluation of In-Plane Brightness and Darkness Difference in Case of Being Viewed from any One Direction)—In a case where the molded article was observed from an arbitrary direction, the brightest region was determined as A, and the darkest region was determined as B. In the region A, reflectance in a case where the molded article was set on a sample holder so that the first direction was an incident surface was defined as a highlight reflectance (R_{H}), and in the region B, reflectance in a case where the molded article was set so that the first direction of the region A was an incident surface was defined as a shade reflectance (R_{S}). A ratio (R_{H}/R_{S}) of the reflectance was measured in the same manner as the evaluation of the brightness and darkness contrast.

In-plane brightness and darkness contrast was evaluated according to the following standard. As an evaluation result, C is preferable, B is more preferable, and A is particularly preferable.

<<Evaluation Standard>>

A: ratio (R_{H}/R_{S}) of the highlight reflectance (R_{H}) to the shade reflectance (R_{S}) was 100 or more.

B: ratio (R_{H}/R_{S}) of the highlight reflectance (R_{H}) to the shade reflectance (R_{S}) was 10 or more and less than 100.

C: ratio (R_{H}/R_{S}) of the highlight reflectance (R_{H}) to the shade reflectance (R_{S}) was 1.2 or more and less than 10.

D: ratio (R_{H}/R_{S}) of the highlight reflectance (R_{H}) to the shade reflectance (R_{S}) was less than 1.2.

—Evaluation of Brilliant Brilliance (Evaluation of Steepness of Change in Brightness in Case of Being Viewed from any One Direction)—

Reflectances of the two regions A and B sandwiching a boundary where the reflectance changed abruptly were measured under the following conditions.

In the region A, reflectance in a case where the molded article was set on a sample holder so that the first direction was an incident surface was defined as a highlight reflectance (R_{H}), and in the region B, reflectance in a case where the molded article was set on a sample holder so that the first direction of the region A was an incident surface was defined as a shade reflectance (R_{S}). A ratio (R_{H}/R_{S}) of the reflectance was measured in the same manner as the evaluation of the brightness and darkness contrast for each observing direction.

Furthermore, a distance between the region A and the region B was measured.

Brilliant brilliance was evaluated by A to D according to the following standard.

A: ratio (R_{H}/R_{S}) of the highlight reflectance (R_{H}) to the shade reflectance (R_{S}) was 100 or more, and a distance between the regions was within 1 mm.

B: ratio (R_{H}/R_{S}) of the highlight reflectance (R_{H}) to the shade reflectance (R_{S}) was 10 or more and less than 100, and a distance between the regions was within 1 mm.

C: ratio (R_{H}/R_{S}) of the highlight reflectance (R_{H}) to the shade reflectance (R_{S}) was 1.2 or more and less than 10, and a distance between the regions was within 1 mm.

D: ratio (R_{H}/R_{S}) of the highlight reflectance (R_{H}) to the shade reflectance (R_{S}) was less than 1.2, or a distance between the regions was more than 1 mm.

—Evaluation of Brilliance in Case of Being Held in Hand and Tilted (Evaluation of Difference in Brightness in Case of Being Viewed from Low Angle)—

A ratio (R_{H}/R_{S}) of reflectance was measured in the same manner as the evaluation of the in-plane brightness and darkness contrast, except that the incidence angle and the light-receiving angle were set within a range of the incidence angle of −45° and the light-receiving angle of −90° to −60° or 60° to 90°.

Brilliance in a case of being held in a hand and tilted was evaluated according to the following standard.

A: ratio (R_{H}/R_{S}) of the highlight reflectance (R_{H}) to the shade reflectance (R_{S}) was 100 or more.

B: ratio (R_{H}/R_{S}) of the highlight reflectance (R_{H}) to the shade reflectance (R_{S}) was 10 or more and less than 100.

C: ratio (R_{H}/R_{S}) of the highlight reflectance (R_{H}) to the shade reflectance (R_{S}) was 1.2 or more and less than 10.

D: ratio (R_{H}/R_{S}) of the highlight reflectance (R_{H}) to the shade reflectance (R_{S}) was less than 1.2.

—Evaluation of Brilliance on Table (Evaluation of Difference in Brightness at Observation Angle Assumed for Decorative Use)—A ratio (R_{H}/Rs) of reflectance was measured in the same manner as the evaluation of the in-plane brightness and darkness contrast, except that the incidence angle and the light-receiving angle were set within a range of the incidence angle of =30° and the light-receiving angle of −60° to 60°.

Brilliance on a table was evaluated according to the following standard.

A: ratio (R_{H}/R_{S}) of the highlight reflectance (R_{H}) to the shade reflectance (R_{S}) was 100 or more.

B: ratio (R_{H}/R_{S}) of the highlight reflectance (R_{H}) to the shade reflectance (R_{S}) was 10 or more and less than 100.

C: ratio (R_{H}/R_{S}) of the highlight reflectance (R_{H}) to the shade reflectance (R_{S}) was 1.2 or more and less than 10.

D: ratio (R_{H}/R_{S}) of the highlight reflectance (R_{H}) to the shade reflectance (R_{S}) was less than 1.2.

—Evaluation of Brilliance Viewed from Front (Evaluation of Difference in B4rightness from Right in Front)—

A ratio (R_{H}/R_{S}) of reflectance was measured in the same manner as the evaluation of the in-plane brightness and darkness contrast, except that the incidence angle and the light-receiving angle were set within a range of the incidence angle of 0° and the light-receiving angle of −20° to 20°.

Brilliance viewed from the front was evaluated according to the following standard.

A: ratio (R_{H}/R_{S}) of the highlight reflectance (R_{H}) to the shade reflectance (R_{S}) was 100 or more.

B: ratio (R_{H}/R_{S}) of the highlight reflectance (R_{H}) to the shade reflectance (R_{S}) was less than 100.

—Evaluation of Visibility of Convex Structure—

Visibility of the convex structure in a case where the obtained molded article was viewed was evaluated.

A: shape of the convex structure was not visible.

B: shape of the convex structure was visible.

—Rainbow Unevenness Due to Interference—

An evaluation was made as to whether or not rainbow unevenness was visible in a case where the obtained molded article was viewed.

A: rainbow unevenness was not visible.

B: rainbow unevenness was visible.

—Dependence of Change in Tint on Viewing Angle (Evaluation as to Whether Larger Change in Tint can be Obtained Depending on Viewing Angle)—

The obtained molded article was evaluated for changes in tint in a case of being viewed from angles of 0° and 45° (for example, yellow at 0° direction, blue at 45° direction, and the like).

A: there was a large change in tint between a case of viewing from the 0° direction and a case of viewing from the 45° direction.

B: there was a slight change in tint between a case of viewing from the 0° direction and a case of viewing from the 45° direction.

The evaluation results are shown in Tables 1 and 2.

### Examples 2 to 11

Evaluations were performed using molded articles 2 to 11 obtained by changing the convex pattern in Example 1. The evaluation results of Examples 2 to 11 are also shown in Table 2.

In addition, in Example 11, a reflective layer was produced by the following method.

A film of niobium oxide having a thickness of 100 nm was formed on the convex surface of the base material having a convex shape using a sputtering film forming apparatus (for example, RAS-1100C manufactured by SHINCRON CO., LTD.). A film of silicon oxide was formed on the niobium oxide layer to a thickness of 100 nm. The work of alternately forming the films of niobide oxide and silicon oxide was repeated, and a total of 8 layers were laminated until the thickness was 800 nm to obtain a molded article. The molded article includes the base material having a convex pattern and the reflective layer.

### Comparative Example 1

A molded article 12 was produced in the same manner as in Example 1, except that the coating liquid 1 for forming a cholesteric liquid crystal layer was not applied onto the rubbing-treated surface of the alignment layer 1 in Example 1, and no cholesteric liquid crystal layer was formed.

### Comparative Example 2

A molded article 13 was produced using, instead of the transparent body having a convex pattern, a (smooth) PET base material having no convex pattern (A4300, manufactured by Toyobo Co., Ltd., thickness: 50 μm).

### Comparative Examples 3 and 4

Molded articles 14 and 15 were produced by changing the cross-sectional shape of the convex structure of the transparent body to the conditions shown in Table 1.

The evaluation results of Comparative Examples 1 to 4 are also shown in Table 1.

TABLE 1

| | | | | Comparative | Comparative | Comparative | Comparative |
|---|---|---|---|---|---|---|---|
| | | | Example 1 | Example 1 | Example 2 | Example 3 | Example 4 |
| Reflective layer | | | Liquid | None | Liquid | Liquid | Liquid |
| | | | crystal layer | | crystal layer | crystal layer | crystal layer |
| Reflective layer having convex structure | | | Y | Y | N | Y | Y |
| Region A | Average (Φ_{AVE}) of positive tilt angles in | ° | 3.4 | 3.4 | 0 | 2 | 10 |
| | first direction | | | | | | |
| | Average (Φ_{AVE}) of positive tilt angles in | ° | 0 | 0 | 0 | 1 | 4 |
| | second direction | | | | | | |
| | Region size | μm | 150 | 150 | 150 | 150 | 150 |
| Cross-sectional shape of | Tilt angle (Φ_{1/2}) of cross-sectional shape | ° | 5 | 5 | 0 | 2 | 10 |
| convex structure | at intermediate height point (H_{1/2}) | | | | | | |
| obtained by cutting | between local maximum point and local | | | | | | |
| region A in first direction | minimum point of convex structure | | | | | | |
| | Area proportion of region where tilt | % | 20 | 20 | 100 | 100 | 0 |
| | angle (Φ) of convex structure is 0° ≤ Φ < | | | | | | |
| | 3° | | | | | | |
| | Area proportion of region where tilt | % | 65 | 65 | 0 | 0 | 100 |
| | angle (Φ) of convex structure is 3° ≤ Φ < | | | | | | |
| | 45° | | | | | | |
| | Area proportion of region where tilt | % | 60 | 60 | 0 | 0 | 0 |
| | angle (Φ) of convex structure is 3° ≤ Φ < | | | | | | |
| | 7° | | | | | | |
| | Distance between local minimum points | μm | 30 | 30 | — | 30 | 30 |
| Region B | Average (Φ_{AVE}) of positive tilt angles in | ° | 3.4 | 3.4 | 0 | 2 | 10 |
| | first direction | | | | | | |
| | Average (Φ_{AVE}) of positive tilt angles in | ° | 0 | 0 | 0 | 1 | 4 |
| | second direction | | | | | | |
| | Region size | μm | 150 | 150 | 150 | 150 | 150 |
| | Angle formed by second direction of | ° | 90 | 90 | — | 90 | 90 |
| | region A and second direction of region | | | | | | |
| | B | | | | | | |
| Cross-sectional shape of | Tilt angle (Φ_{1/2}) of cross-sectional shape | ° | 5 | 5 | 0 | 2 | 10 |
| convex structure | at intermediate height point (H_{1/2}) | | | | | | |
| obtained by cutting | between local maximum point and local | | | | | | |
| region B in first direction | minimum point of convex structure | | | | | | |
| | Area proportion of region where tilt | % | 20 | 20 | 100 | 100 | 0 |
| | angle (Φ) of convex structure is 0° ≤ Φ < | | | | | | |
| | 3° | | | | | | |
| | Area proportion of region where tilt | % | 65 | 65 | 0 | 0 | 100 |
| | angle (Φ) of convex structure is 3° ≤ Φ < | | | | | | |
| | 45° | | | | | | |
| | Area proportion of region where tilt | % | 60 | 60 | 0 | 0 | 0 |
| | angle (Φ) of convex structure is 3° ≤ Φ < | | | | | | |
| | 7° | | | | | | |
| | Distance between local minimum points | μm | 30 | 30 | — | 30 | 30 |

| | | | | | | |
|---|---|---|---|---|---|---|
| Distance between region A and region B | mm | 1 | 1 | — | 1 | 1 |

| | | | | | | |
|---|---|---|---|---|---|---|
| Evaluation result | Change in tint for each viewing direction | A | D | D | D | D |

TABLE 2

| | | | Example | Example | Example | Example | Example | Example |
|---|---|---|---|---|---|---|---|---|
| | | | 1 | 2 | 3 | 4 | 5 | 6 |
| Reflective layer having convex | | | Y | Y | Y | Y | Y | Y |
| structure | | | | | | | | |
| Region A | Average (Φ_{AVE}) | ° | 3.4 | 3.4 | 3.4 | 3.4 | 3.4 | 3.2 |
| | of positive tilt | | | | | | | |
| | angles in first | | | | | | | |
| | direction | | | | | | | |
| | Average (Φ_{AVE}) | ° | 0 | 0 | 0 | 0 | 0 | 0 |
| | of positive tilt | | | | | | | |
| | angles in second | | | | | | | |
| | direction | | | | | | | |
| | Region size | μm | 150 | 120 | 10,000 | 170 | 320 | 200 |
| Region B having different second | | | Y | Y | N | Y | Y | Y |
| direction with region A | | | | | | | | |
| Distance between region A and | | mm | 1.0 | 0.8 | N | 1.2 | 0.5 | 0.9 |
| region B | | | | | | | | |
| Cross-sectional | Tilt angle (Φ_{1/2}) | ° | 5 | 5 | 5 | 5 | 65 | 5 |
| shape of | of cross- | | | | | | | |
| convex | sectional shape | | | | | | | |
| structure | at intermediate | | | | | | | |
| obtained by | height point | | | | | | | |
| cutting in first | (H_{1/2}) between | | | | | | | |
| direction | local maximum | | | | | | | |
| | point and local | | | | | | | |
| | minimum point | | | | | | | |
| | of convex | | | | | | | |
| | structure | | | | | | | |
| | Area proportion | % | 20 | 20 | 20 | 20 | 20 | 55 |
| | of legion where | | | | | | | |
| | tilt angle (Φ) of | | | | | | | |
| | convex structure | | | | | | | |
| | is 0° ≤ Φ < 3° | | | | | | | |
| | Area proportion | % | 65 | 65 | 65 | 65 | 65 | 45 |
| | of legion where | | | | | | | |
| | tilt angle (Φ) of | | | | | | | |
| | convex structure | | | | | | | |
| | is 3° ≤ Φ < 45° | | | | | | | |
| | Area proportion | % | 60 | 60 | 60 | 60 | 60 | 40 |
| | of legion where | | | | | | | |
| | tilt angle (Φ) of | | | | | | | |
| | convex structure | | | | | | | |
| | is 3° ≤ Φ < 7° | | | | | | | |
| | Distance | μm | 30 | 30 | 30 | 30 | 30 | 30 |
| | between local | | | | | | | |
| | minimum points | | | | | | | |

| Reflective layer | | Liquid | Liquid | Liquid | Liquid | Liquid | Liquid |
|---|---|---|---|---|---|---|---|
| | | crystal | crystal | crystal | crystal | crystal | crystal |
| | | layer | layer | layer | layer | layer | layer |
| Evaluation | Change in tint for | A | A | A | A | A | B |
| result | each viewing | | | | | | |
| | direction | | | | | | |
| | Visibility of tint | A | B | A | A | A | A |
| | change region | | | | | | |
| | In-plane brightness | A | A | D | A | A | B |
| | and darkness | | | | | | |
| | contrast | | | | | | |
| | Brilliant brilliance | A | A | D | D | A | B |
| | Brilliance in case of | B | B | B | B | A | B |
| | being held in hand | | | | | | |
| | and tilted | | | | | | |
| | Brilliance on table | A | A | D | A | D | B |
| | Brilliance viewed | A | A | D | A | D | B |
| | from front | | | | | | |
| | Visibility of convex | A | A | A | A | A | A |
| | structure | | | | | | |
| | Rainbow unevenness | A | A | A | A | A | A |
| | due to interference | | | | | | |
| | Dependence of | A | A | A | A | A | A |
| | change in tint on | | | | | | |
| | viewing angle | | | | | | |

| | | | Example | Example | Example | Example | Example |
|---|---|---|---|---|---|---|---|
| | | | 7 | 8 | 9 | 10 | 11 |
| Reflective layer having convex | | | Y | Y | Y | Y | Y |
| structure | | | | | | | |
| Region A | Average (Φ_{AVE}) | ° | 3.7 | 11.7 | 3.4 | 3.4 | 3.4 |
| | of positive tilt | | | | | | |
| | angles in first | | | | | | |
| | direction | | | | | | |
| | Average (Φ_{AVE}) | ° | 0 | 0 | 0 | 0 | 0 |
| | of positive tilt | | | | | | |
| | angles in second | | | | | | |
| | direction | | | | | | |
| | Region size | μm | 180 | 800 | 10,000 | 25,000 | 90,000 |
| Region B having different second | | | Y | Y | Y | Y | Y |
| direction with region A | | | | | | | |
| Distance between region A and | | mm | 0.1 | 0.01 | 0.2 | 0.05 | 0.9 |
| region B | | | | | | | |
| Cross-sectional | Tilt angle (Φ_{1/2}) | ° | 5 | 5 | 5 | 5 | 5 |
| shape of | of cross- | | | | | | |
| convex | sectional shape | | | | | | |
| structure | at intermediate | | | | | | |
| obtained by | height point | | | | | | |
| cutting in first | (H_{1/2}) between | | | | | | |
| direction | local maximum | | | | | | |
| | point and local | | | | | | |
| | minimum point | | | | | | |
| | of convex | | | | | | |
| | structure | | | | | | |
| | Area proportion | % | 20 | 20 | 20 | 20 | 20 |
| | of legion where | | | | | | |
| | tilt angle (Φ) of | | | | | | |
| | convex structure | | | | | | |
| | is 0° ≤ Φ < 3° | | | | | | |
| | Area proportion | % | 25 | 65 | 65 | 65 | 65 |
| | of legion where | | | | | | |
| | tilt angle (Φ) of | | | | | | |
| | convex structure | | | | | | |
| | is 3° ≤ Φ < 45° | | | | | | |
| | Area proportion | % | 10 | 10 | 60 | 60 | 60 |
| | of legion where | | | | | | |
| | tilt angle (Φ) of | | | | | | |
| | convex structure | | | | | | |
| | is 3° ≤ Φ < 7° | | | | | | |
| | Distance | μm | 30 | 30 | 120 | 8 | 30 |
| | between local | | | | | | |
| | minimum points | | | | | | |

| Reflective layer | | Liquid | Liquid | Liquid | Liquid | Inorganic |
|---|---|---|---|---|---|---|
| | | crystal | crystal | crystal | crystal | sputtering |
| | | layer | layer | layer | layer | film |
| Evaluation | Change in tint for | C | B | A | A | A |
| result | each viewing | | | | | |
| | direction | | | | | |
| | Visibility of tint | A | A | A | A | A |
| | change region | | | | | |
| | In-plane brightness | C | B | A | A | A |
| | and darkness | | | | | |
| | contrast | | | | | |
| | Brilliant brilliance | C | B | A | A | A |
| | Brilliance in case of | B | B | B | B | B |
| | being held in hand | | | | | |
| | and tilted | | | | | |
| | Brilliance on table | C | B | A | A | A |
| | Brilliance viewed | C | C | A | A | A |
| | from front | | | | | |
| | Visibility of convex | A | A | B | A | A |
| | structure | | | | | |
| | Rainbow unevenness | A | A | A | B | A |
| | due to interference | | | | | |
| | Dependence of | A | A | A | A | B |
| | change in tint on | | | | | |
| | viewing angle | | | | | |

As shown in Tables 1 and 2, the decorative films of Examples 1 to 11, which are the decorative film according to the embodiment of the present disclosure, were decorative films rich in tint change depending on the viewing direction, as compared to the decorative films of Comparative Examples 1 to 4.

### Example 12

### Display Decorative Film

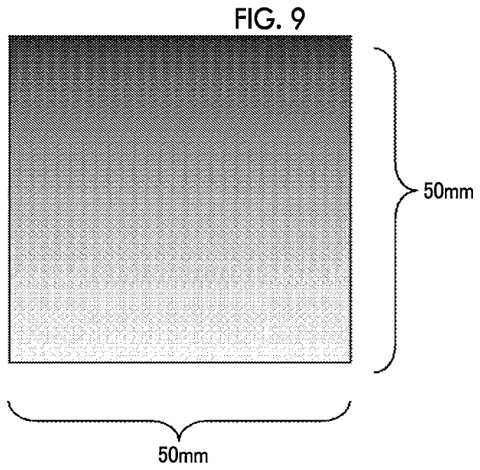

A molded article A-1 was produced in the same manner as in Example 1, except that, in Example 1, the coating liquid 1 for forming a cholesteric liquid crystal layer prepared above was applied onto the rubbing-treated surface of the alignment layer 1 with a wire bar coater, and dried at 85° C. for 120 seconds. Thereafter, as shown in FIG. 9, through a mask pattern, light from a metal halide lamp (MAL625NAL manufactured by GS Yuasa International Ltd.) with an exposure amount of 30 mJ/cm² was irradiated to the liquid crystal layer portion to perform an isomerization treatment of a reflected wavelength, thereby forming a black layer. After the above-described process, the liquid crystal layer exhibited a reflection pattern of a gradation color of blue to red.

Further, a retardation layer of a ¼ wavelength plate was transferred to the cholesteric liquid crystal layer on a surface opposite to the surface on which the liquid crystal layer of the base material was formed by the method described in paragraphs 0170 and 0171 of JP2017-215558A, thereby forming a molded article A-2.

Further, on the side of the transparent body having the linear convex pattern (A), the retardation layer of the ¼ wavelength plate was transferred to the transparent body having the linear convex pattern (A) (on the smooth surface side without the convex pattern) and laminated by the method described in paragraphs 0170 and 0171 of JP2017-215558A, thereby forming a molded article A-3.

In this case, each ¼ wavelength plate was disposed such that transmittance was maximized in a case where linearly polarized light was transmitted through the liquid crystal layer.

Further, an acrylic pressure sensitive adhesive (SK-Dyne SG-50Y, manufactured by Soken Chemical & Engineering Co., Ltd.) was applied onto the retardation layer of the ¼ wavelength plate, which was laminated on the side of the transparent body having the linear convex pattern (A), with a comma coater, and dried at 120° C. for 2 minutes, thereby forming a resin layer A-4 (adhesive layer) having a layer thickness of 20 μm.

Further, a liquid crystal axisymmetric polarization converter (RADPOL4, manufactured by ARCoptix) was rubbed on the resin layer A-4 with a silicone rubber roller at room temperature to form a molded article A-5.

The molded article A-5 was installed on a display unit of ipad-pro (manufactured by Apple Inc., liquid crystal display) so that the liquid crystal axisymmetric polarization converter came to the outermost surface. In this case, the molded article was disposed in a direction in which transmittance of linearly polarized light output from the display was maximized. In a case where display of the display was turned on, when light transmitted through the liquid crystal axisymmetric converter was set to be the linearly polarized light, the displayed image on the display was clearly visible, and the pattern of the decorative film was hardly visible. On the other hand, in a case where display of the display was turned off, when the liquid crystal axisymmetric converter was set to transmit all light, the reflected color of the decorative film (gradation of blue to red) was clearly visible, and a pattern with high lustrousness and rich reflected color change depending on the viewing angle was also visible.

### EXPLANATION OF REFERENCES

20: decorative film

22: base material

24: colored layer

26: alignment layer

28: cholesteric liquid crystal layer (reflective layer)

30: adhesive layer

32: colored layer

34: base material

36: resin layer

38: alignment layer

40: cholesteric liquid crystal layer (reflective layer)

42: adhesive layer

44: glass panel

50: decorative film

60: transparent body having linear convex structure

70: decorative molded article

80: decorative molded article

90: decorative molded article

100: decorative panel

110: retardation layer of ¼ wavelength plate

112: retardation layer of ¼ wavelength plate

114: adhesive layer

116: decorative molded article

The disclosure of Japanese Patent Application No. 2020-129501 filed on Jul. 30, 2020 and the disclosure of Japanese Patent Application No. 2020-215029 filed on Dec. 24, 2020 are incorporated in the present specification by reference.

All documents, patent applications, and technical standards described in the present specification are incorporated herein by reference to the same extent as in a case of being specifically and individually noted that individual documents, patent applications, and technical standards are incorporated by reference.

What is claimed is:

1. A decorative film comprising:
a base material; and
a reflective layer having a convex structure,
wherein, in a cross section obtained by cutting the convex structure in a direction perpendicular to a plane direction of the decorative film, in a case where a direction in which an average Φ_{AVE} of positive tilt angles is a largest is defined as a first direction and a direction in which the average Φ_{AVE} of the positive tilt angles is a smallest is defined as a second direction, the decorative film has a region A in which Φ_{AVE} in the first direction is 3° or more and Φ_{AVE} in the second direction is less than 3°.

2. The decorative film according to claim 1,
wherein the region A in the plane direction of the decorative film includes a region having a size equal to or larger than a circle having a radius of 150 μm.

3. The decorative film according to claim 1,
wherein the decorative film further has a region B in-plane, which has a second direction different from the second direction of the region A.

4. The decorative film according to claim 3,
wherein a distance between the region A and the region B in the plane direction of the decorative film is 1 mm or less.

5. The decorative film according to claim 1,
wherein, in a cross-sectional shape obtained by cutting the convex structure in the region A in the direction perpendicular to the plane direction of the decorative film and in the first direction, a tilt angleΦ_{1/2} at an intermediate height point H_{1/2} between a local maximum point and a local minimum point of the positive tilt angle is 3° or more and less than 60°.

6. The decorative film according to claim 1,
wherein, in a cross-sectional shape obtained by cutting the convex structure in the region A in the direction perpendicular to the plane direction of the decorative film and in the first direction, a tilt angle Φ_{1/2} at an intermediate height point Hi12 between a local maximum point and a local minimum point of the positive tilt angle is 60° or more.

7. The decorative film according to claim 1,
wherein, in a cross-sectional shape obtained by cutting the convex structure in the region A in the direction perpendicular to the plane direction of the decorative film and in the first direction, an area proportion of a region where a tilt angle Φ is 0° or more and less than 3° is 50% or less with respect to a total area of the region A.

8. The decorative film according to claim 1,
wherein, in a cross-sectional shape obtained by cutting the convex structure in the region A in the direction perpendicular to the plane direction of the decorative film and in the first direction, an area proportion of a region where a tilt angle Φ is 3° or more and less than 45° is 40% or more with respect to a total area of the region A.

9. The decorative film according to claim 1,
wherein, in a cross-sectional shape obtained by cutting the convex structure in the region A in the direction perpendicular to the plane direction of the decorative film and in the first direction, an area proportion of a region where a tilt angle Φ is 3° or more and less than 7° is 40% or more with respect to a total area of the region A.

10. The decorative film according to claim 1,
wherein, in a cross-sectional shape obtained by cutting the convex structure in the region A in the direction perpendicular to the plane direction of the decorative film and in the first direction, a distance between local minimum points of the positive tilt angles is less than 100 μm.

11. The decorative film according to claim 1,
wherein, in a cross-sectional shape obtained by cutting the convex structure in the region A in the direction perpendicular to the plane direction of the decorative film and in the first direction, a distance between local minimum points of the positive tilt angles is 10 μm or more.

12. The decorative film according to claim 1,
wherein the reflective layer includes a liquid crystal in a cholesteric alignment state.

13. The decorative film according to claim 1,
wherein the convex structure is a linear convex structure.

14. The decorative film according to claim 13,
wherein the linear convex structure includes a linear convex structure having a ratio L/W of a length L to an average line width W of 5 or more.

15. A decorative molded article comprising:
the decorative film according to claim 1; or
a molded product of the decorative film.

16. A decorative panel comprising:
the decorative film according to claim 1; or
a molded product of the decorative film.

17. An electronic device comprising:
the decorative panel according to claim 16.
